(19) United States
(12) Patent Application Publication
(10) Pub. No.: US 2007/0294514 A1
(43) Pub. Date: Dec. 20, 2007

(54) Picture Processing Engine and Picture Processing System

(76) Inventors: Koji Hosogi, Hiratsuka (JP); Masakazu Ehama, Ebina (JP); Hiroaki Nakata, Yokohama (JP); Kenichi Iwata, Kokubunji (JP); Seiji Mochizuki, Kodaira (JP); Takafumi Yuasa, Yokohama (JP); Yukifumi Kobayashi, Kodaira (JP); Tetsuya Shibayama, Kodaira (JP); Hiroshi Ueda, Akishima (JP); Masaki Nobori, Hachiouji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/688,894

(22) Filed: Mar. 21, 2007

(30) Foreign Application Priority Data
Jun. 20, 2006 (JP) 2006-170382

(51) Int. Cl. G06F 9/30

(52) U.S. Cl. 712/212; 712/E09.016

(57) ABSTRACT

To provide a technique to reduce power consumption when carrying out image processing by processors. For the purpose of this, for example, a means for specifying a two-dimensional source register and destination register is provided in an operand of an instruction, and the processor includes a means which executes calculation using a plurality of source registers in a plurality of cycles and obtains a plurality of destinations. Moreover, in an instruction to obtain a destination using a plurality of source registers and consuming a plurality of cycles, a data rounding processing part is connected to a final stage of a pipeline. With such configurations, the power consumed when reading an instruction memory is reduced by reducing the access frequency to the instruction memory, for example.

### INCORPORATION BY REFERENCE

The present application claims priority from Japanese application JP2006-170382 filed on Jun. 20, 2006, the content of which is hereby incorporated by reference into this application.

### BACKGROUND OF THE INVENTION

The present invention is in the technical field of picture processing engines and picture processing systems, and in particular relates to a picture processing engine, in which a CPU and a direct memory access controller are bus connected to each other, and a picture processing system including the same.

As the semiconductor process is refined, techniques called SOC (system on chip) for achieving a large-scale system on one LSI, and SIP (system in package) for mounting a plurality of LSIs in one package are becoming mainstream. Such a large scale integration of logic, as seen in embedded type applications, has allowed totally different functions, such as a CPU core and a video codec accelerator or a large-scale DMAC module, to be mounted into one LSI.

Moreover, the refinement of semiconductor process increases a leakage current of LSI in the steady state, and thus an increase in power consumption due to the leakage current presents a problem. In recent years, a reduction in power consumption has been achieved by stopping clock sources to unused modules or by shutting off power supply, and the like. The above reduction in power consumption is a reduction in power consumption in the standby state, such as in a sleep mode.

On the other hand, when viewing and listening to a picture with a portable terminal or the like, because almost all modules in LSI operate as in the steady state, the approaches to reduce power consumption in the standby state described above cannot be used. The power consumption in the steady state is proportional to the operation frequency, the amount of logic, the activation rate of transistors, and to the square of the supply voltage. Accordingly, the reduction in power consumption can be achieved by reducing these factors.

The reduction in the operation frequency can be achieved by increasing the throughput to process in one cycle by parallelizing or the like. Although this tends to increase the required amount of logic and thus increase the power consumption, a low speed operation is possible and the timing critical paths can be reduced, thereby allowing the supply voltage to be reduced and accordingly allowing the power consumption to be reduced. Accordingly, in recent years, the reduction in power consumption due to an improvement in the degree of parallelism due to a SIMD type ALU and a multiprocessor, or the like, rather than an improvement in the operation frequency, is becoming mainstream.

JP-2000-57111 shows a SIMD type ALU. This technique increases the throughput to calculate in one cycle by causing arithmetic logical units to operate in parallel, thus achieving a reduction in the operation frequency. This SIMD type ALU is effective in carrying out the same calculation for each pixel like in image processing.

JP-2000-298652 shows a multiprocessor. Here, an instruction memory which multiprocessors use is shared to thereby reduce the total amount of logic of the instruction memory and thus achieve a reduction in power consumption.

JP-2001-100977 shows a VLIW type CPU. In VLIW, arithmetic logical units are arranged in parallel, which are then caused to operate in parallel, thereby reducing the required processing cycles and thus achieving a reduction in power consumption.

### SUMMARY OF THE INVENTION

JP-A-2000-57111 discloses a SIMD type ALU. A general image processing is an algorithm for executing the same calculation to the whole two-dimensional block. In achieving this by means of a SIMD type ALU, the same instruction is supplied every cycle, in which only the read register number and write register number of a general-purpose register vary. This means that an instruction fetch is carried out every cycle, and thus a memory in which the instruction is stored should be accessed every cycle. The rate of power which the memory consumes is relatively high relative to the entire power consumption of the LSI. Accordingly, reading an instruction memory every cycle increases the power consumption.

Moreover, the SIMD type ALU is configured to carry out calculation to the limited input data. For example, in carrying out a vertical convolution calculation or the like, the calculation of each element is carried out by a plurality of instruction sequences and finally each calculation result is added. If a carry is taken into consideration, the processing cycles of a bit extension as a pre-processing, a rounding processing as a post-processing, and the like, will increase as compared with the processing cycle of the actual convolution calculation. Accordingly, a high operation frequency is required and thus the power consumption will increase.

JP-A-2000-298652 discloses a reduction in power consumption by reducing the area of multiprocessors. According to this document, only a processor whose process is active will access to a shared instruction memory. Accordingly, when processes are active in a plurality of processors simultaneously, a conflict of the instruction memory accesses will occur and thus the operation rate of the processors will substantially decrease to cause a performance decrease. As such, the instruction supply of a processor depends on the instruction memory accessing, and the ratio of power to consume is also high in this case.

JP-A-2001-100977 discloses a VLIW type CPU. According to this method, as the number of arithmetic logical units to be operated in parallel is increased, the number of instructions to read in one cycle also increases and thus the power consumption is high. Moreover, in proportion to the number of arithmetic logical units, the number of register ports increases and the area cost is high and thus this also increases the power consumption.

Then, the present invention is intended to provide a technique to reduce power consumption in carrying out image processing by means of processors.

For example, a means to specify a two-dimensional source register and a two-dimensional destination register is provided in an operand of an instruction, and this processor includes a means which carries out a calculation using a plurality of source registers in a plurality of cycles and thus obtains a plurality of destinations. Moreover, in an instruction to obtain a destination using a plurality of source registers and consuming a plurality of cycles, a data rounding processing part is connected to a final stage of a pipeline.

Moreover, a plurality of CPUs are connected in series and a shared type instruction memory is shared for use. In this case, an instruction operand of each CPU includes a field for controlling a synchronization between adjacent CPUs, and a means for carrying out the synchronization control is provided.

With such configuration, a power consumed in reading an instruction memory is reduced by reducing the access frequency to the instruction memory, for example. Moreover, by reducing the number of instructions and sharing an instruction memory, a total capacity of the instruction memory is reduced, thus reducing the number of transistors to be charged and discharged and achieving low power consumption.

### BRIEF DESCRIPTION OF THE DRAWINGS

FIG. 1 is a block diagram of an embedded system in this embodiment.

FIG. 2 is a block diagram of a picture processing part 6 in this embodiment.

FIG. 3 is a block diagram of a shift type bus 50 in this embodiment.

FIG. 4 is a block diagram of a shift register slot 500 in this embodiment.

FIG. 5 is a timing chart of the shifted type bus 50 in this embodiment.

FIG. 6 is a block diagram of a picture processing engine 66 in this embodiment.

FIG. 7 is an example of calculation in this embodiment.

FIG. 8 is a block diagram of a CPU part 30 in this embodiment.

FIG. 9 is a flowchart for generating a control line 308 which controls a read port and write port of a register file 304 which an instruction decode part 303 in this embodiment generates, and for generating an access address 45 of a data memory 35,

FIG. 10 is a block diagram of an instruction memory control part 32 in this embodiment.

FIG. 11 is a block diagram of a data memory control part 33 in this embodiment.

FIG. 12 is a block diagram of a local DMAC 34 in this embodiment.

FIG. 13 is a block diagram of a data path part 36 in this embodiment.

FIG. 14 is a block diagram of a picture processing part 66 in a second embodiment.

FIG. 15 is a block diagram of a vector calculation part 46 in the second embodiment.

FIG. 16 is a block diagram of an instruction memory control part 47 in the second embodiment.

FIG. 17 is a view for explaining a stall condition of an input synchronization in this embodiment.

FIG. 18 is a view for explaining a stall condition of an output synchronization in this embodiment.

FIG. 19 is a view for explaining a stall condition of a synchronization between picture processing engines in this embodiment.

FIG. 20 is a view showing a configuration of a CPU part arranged in the picture processing engine 66 in a third embodiment.

FIG. 21 is a view for explaining an example of inner product calculation.

FIG. 22 is a configuration of a conventional SIMD type arithmetic logical unit.

FIG. 23 is a view showing a configuration of an arithmetic logical unit in this embodiment.

FIG. 24 is a view for explaining an example of inner product calculation that involves transposition.

FIG. 25 is a view for explaining an example of convolution calculation.

FIG. 26 is a view showing a configuration of an arithmetic logical unit in this embodiment.

### DESCRIPTION OF EMBODIMENTS

Hereinafter, embodiments of the present invention will be described in detail using the accompanying drawings.

### Embodiment 1

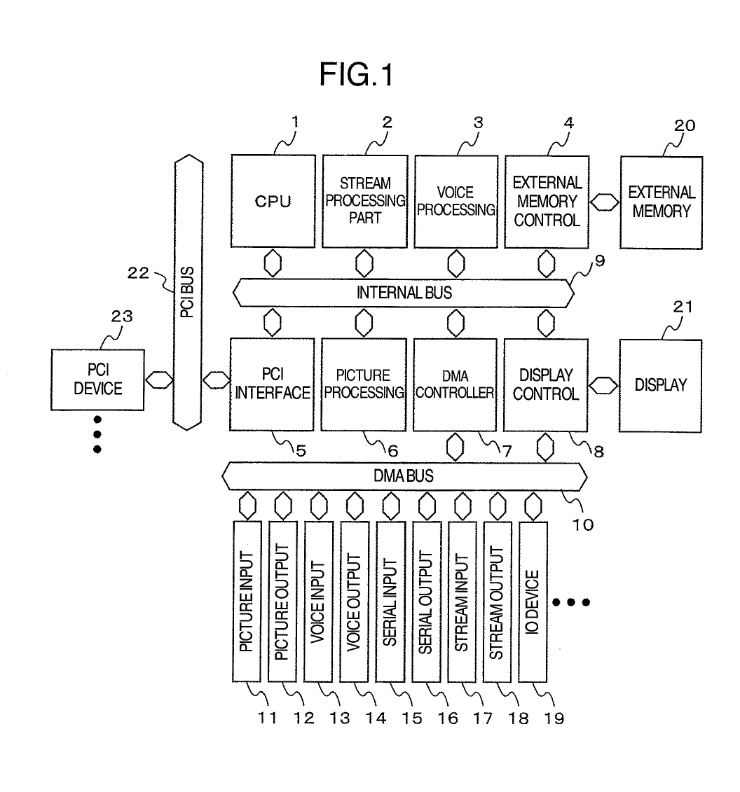

A first embodiment of the present invention will be described in detail with reference to the accompanying drawings. FIG. 1 is a block diagram of an embedded system in this embodiment. In this embedded system, CPU 1 for carrying out a control of the system and a general processing, a stream processing part 2 for carrying out a stream processing, which is one of the processings of a video codec, such as MPEG, a picture processing part 6 which carries out encoding and decoding of the video codec in combination with the stream processing part 2, a voice processing part 3 for carrying out encoding and decoding of a voice codec, such as AAC and MP-3, an external memory control part 4 which controls an access to an external memory 20 consisting of SDRAM and the like, a PCI interface 5 for connecting to a PCI bus 22 which is a standard bus, a display control part 8 for controlling an image display, and a DMA controller 7 which carries out direct memory access to various IO devices, are inter-connected with an internal bus 9.

Various IO devices are connected to the DMA controller 7 via a DMA bus 10. To the IO device are connected a video input part 11 for carrying out a video input such as a camera and NTSC signal, a video output part 12 for outputting videos such as NTSC, a voice input part 13 for inputting voices of a microphone or the like, a voice output part 14 for outputting voices of a loudspeaker, optical output, or the like, a serial input part 15 and a serial output part 16 for carrying out serial transfer of a remote control or the like, a stream input part 17 for inputting streams such as a TCI bus, a stream I/O part 18 for outputting streams of a hard disk or the like, and various IO devices 19. To the PCI bus 22 are connected various PCI devices 23, such as a hard disk and a flash memory.

To the display control part 8 is connected a display 21 which is a display device. The picture processing part 6 is a processing part for carrying out processing to a two-dimensional image, such as video codec, scaling of images, and filtering of images. In this way, this embedded system is a system which has both input and output of video and voice, and carries out picture and voice processings. This system includes, for example, a cellular phone, a HDD recorder, a monitoring device, an on-vehicle image processing device, and the like.

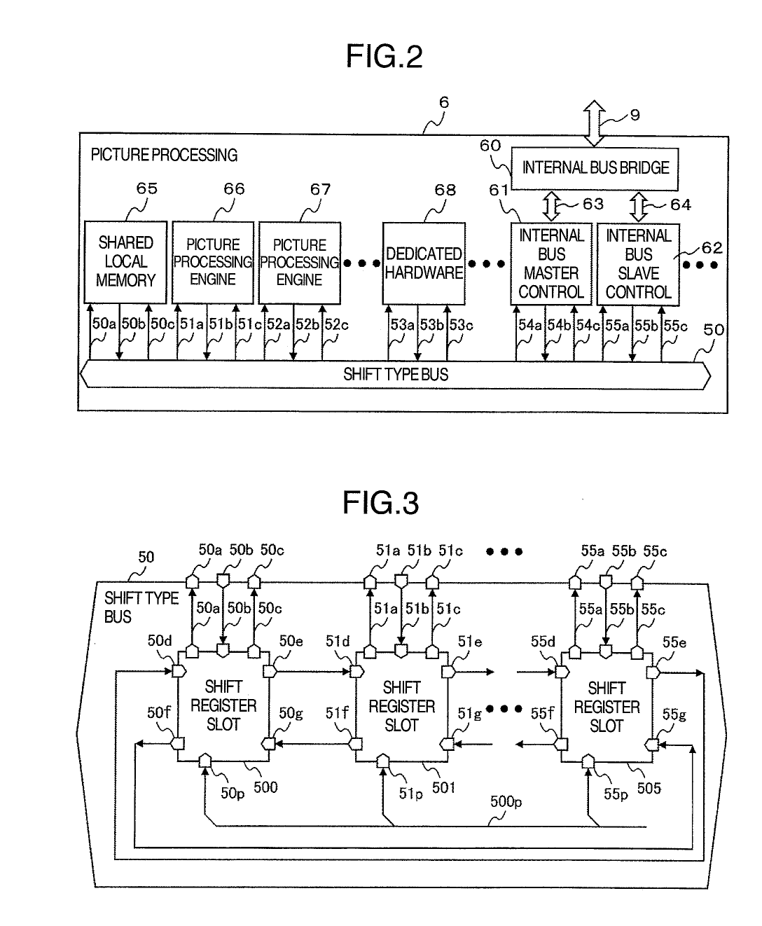

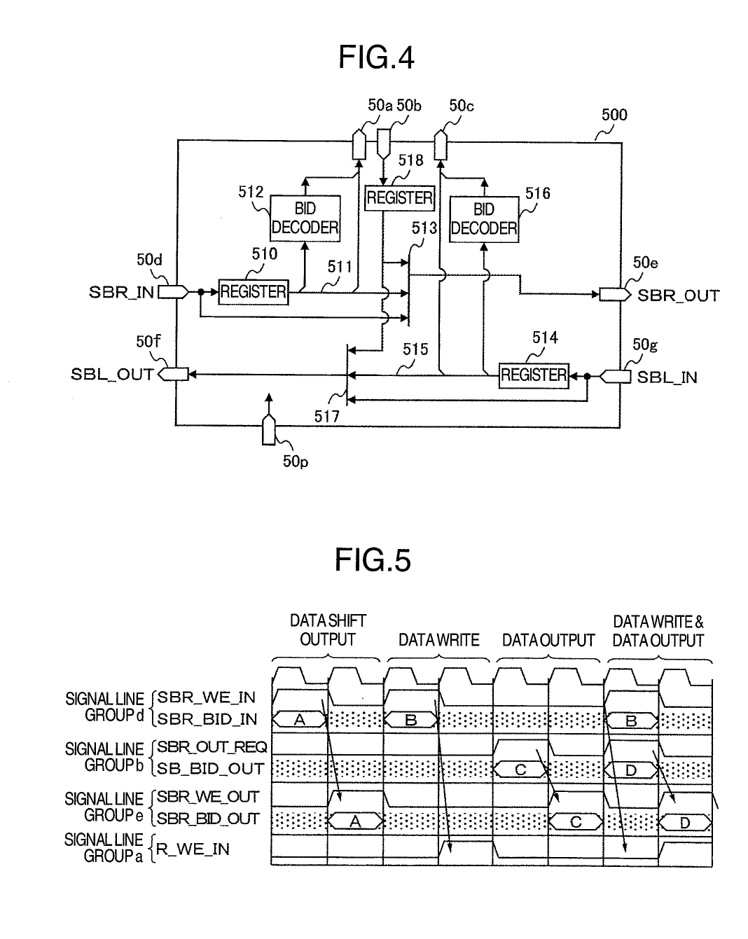

FIG. 2 is a block diagram of the picture processing part 6 in this embodiment. The picture processing part 6 is connected to the internal bus 9 via an internal bus bridge 60. The internal bus bridge 60 is connected to an internal bus master control part 61 via a path 63, and to an internal bus slave control part 62 via a path 64. The internal bus master control part 61 is a block which generates a request of read access or write access and outputs the request to the internal bus bridge 60, with the picture processing part 6 being as a bus master to the internal bus 9. At the time of write access to the internal bus 9, a request, an address, and a data are outputted. At the time of read access to the internal bus 9, a request and an address are outputted and after several cycles a read data is returned. The internal bus slave control part 62 is a block, which receives the read request and write request inputted from the internal bus 9 and inputted via the internal bus bridge 60 and which carries out the processing thereof accordingly. The internal bus bridge 60 is a block, which arbitrates the requests and data which are received and delivered between the internal bus 9 and the internal bus master control part 61 as well as between the internal bus 9 and the internal bus slave control part 62. A shift type bus 50 is a bus which carries out data transfer between blocks in the picture processing part 6. Each block and the shift type bus 50 are connected to each other by three types of signal line groups. First, the shift type bus 50 is described using FIG. 3 and FIG. 4.

FIG. 3 is a block diagram of the shift type bus 50. To the shift type bus 50, the connection is made by means of the three types of signal line groups as an interface to each block. Accordingly, signal line groups 50a, 50b, and 50c are connected to one block, signal line groups 51a, 51b, and 51c are connected to one of the other blocks, and signal line groups 55a, 55b, and 55c are connected to one of the other blocks. The signal line groups 50a, 50b, and 50c are connected to a shift register slot 500, the signal line groups 51a, 51b, and 51c are connected to a shift register slot 501, and the signal line groups 55a, 55b, and 55c are connected to a shift register slot 505. The shift register slots 500, 501, and 505 each are connected in series. For example, an output 50e of the shift register slot 500 is inputted to 51d of the shift register slot 501, and an output 51f of the shift register slot 501 is inputted to 50g of the shift register slot 500. Similarly, an output 55e of the shift register slot 505 is inputted to 50d of the shift register slot 500, and an output 50f of the shift register slot 500 is inputted to 55g of the shift register slot 505. A signal line 500p is the clock stop signal 500p supplied for each shift register slot, and is inputted to a terminal 50p, a terminal 51p, and a terminal 55p. The clock stop signal 500p will be describes later. The shift register slots 500, 501, and 505 have the same configuration except its own block ID described later. Accordingly, the shift register slot 500 is described in detail as the representative.

FIG. 4 is a block diagram of the shift register slot 500. To the shift register slot 500 are connected the signal line groups 50a, 50b, and 50c, i.e., the interface with each block, as well as 50d, 50e, 50f, and 50g, which are signal line groups for the interblock interface. Concerning these signal line groups 50a, 50b, 50c, 50d, 50e, 50f, and 50g, Table 1 to Table 7 summarize the meaning of the signals. Here, the signal line groups 50b, 50d, and 50g are input signals, and the signal line groups 50a, 50c, 50e, and 50f are output signals. In addition, the signal line groups 50a, 50b, 50c, 50d, 50e, 50f, and 50g each are valid values in the same cycle.

TABLE 1
Signal line group 50a

| Signal name | Meaning of the signal |
|---|---|
| R_WE_IN | Write enable from a clockwise shift |
| | type bus |
| R_CMD_IN | Transfer command from the clockwise |
| | shift type bus |
| R_LAST_IN | Transfer end flag from the clockwise |
| | shift type bus |
| R_TRID_IN | Transaction ID from the clockwise shift |
| [3:0] | type bus |
| R_ADDR_IN | Transfer address from the clockwise |
| [12:0] | shift type bus |
| R_DATA_IN | Transfer data from the clockwise shift |
| [63:0] | type bus |

TABLE 2
Signal line group 50b

| Signal name | Meaning of the signal |
|---|---|
| SBR_OUT_REQ | Output request signal to the |
| | clockwise shift type bus |
| SBL_OUT_REQ | Output request signal to a |
| | counterclockwise shift type bus |
| SB_BID_OUT [3:0] | Destination block ID |
| SB_EID_MSK_OUT | Block ID mask |
| [3:0] | |
| SB_CMD_OUT | Transfer command |
| SB_LAST_OUT | Transfer end flag |
| SB_TRID_OUT [3:0] | Transaction ID |
| SB_ADDR_OUT | Transfer address |
| [12:0] | |
| SB_DATA_OUT | Transfer data |
| [63:0] | |

TABLE 3
Signal line group 50c

| Signal name | Meaning of the signal |
|---|---|
| L_WE_IN | Write enable from the counterclockwise |
| | shift type bus |
| L_CMD_IN | Transfer command from the |
| | counterclockwise shift type bus |
| L_LAST_IN | Transfer end flag from the |
| | counterclockwise shift type bus |
| L_TRID_IN | Transaction ID from the |
| [3:0] | counterclockwise shift type bus |
| L_ADDR_IN | Transfer address from the |
| [12:0] | counterclockwise shift type bus |
| L_DATA_IN | Transfer data from the counterclockwise |
| [63:0] | shift type bus |

TABLE 4
Signal line group 50d

| Signal name | Meaning of the signal |
|---|---|
| SBR_WE_IN | Write enable of the clockwise |
| | shift type bus |
| SBR_BID_IN [4:0] | Destination block ID |
| SBR_EID_MSK_IN | Block ID mask |
| [4:0] | |
| SBR_CMD_IN | Transfer command |
| SBR_LAST_IN | Transfer end flag |
| SBR_TRID_IN [3:0] | Transaction ID |
| SBR_ADDR_IN [12:0] | Transfer address |
| SBR_DATA_IN [63:0] | Transfer data |

TABLE 5
Signal line group 50e

| Signal name | Meaning of the signal |
|---|---|
| SBR_WE_OUT | Write enable of the clockwise |
| | shift type bus |
| SBR_BID_OUT [4:0] | Destination block ID |
| SBR_EID_MSK_OUT | Block ID mask |
| [4:01] | |
| SBR_CMD_OUT | Transfer command |
| SBR_LAST_OUT | Transfer end flag |
| SBR_TRID_OUT [3:0] | Transaction ID |
| SBR_ADDR_OUT [12:0] | Transfer address |
| SBR_DATA_OUT [63:0] | Transfer data |

TABLE 6
Signal line group 50f

| Signal name | Meaning of the signal |
|---|---|
| SBL_BID_OUT [4:0] | Destination block ID |
| SBL_EID_MSK_OUT | Block ID mask |
| [4:0] | |
| SBL_CMD_OUT | Transfer command |
| SBL_LAST_OUT | Transfer end flag |
| SBL_TRID_OUT [3:0] | Transaction ID |
| SBL_ADDR_OUT [12:0] | Transfer address |
| SBL_DATA_OUT [63:0] | Transfer data |

TABLE 7
Signal line group 50g

| Signal name | Meaning of the signal |
|---|---|
| SBL_WE_IN | Write enable of the |
| | counterclockwise shift type bus |
| SBL_BID_IN [4:0] | Destination block ID |
| SBL_EID_MSK_IN | Block ID mask |
| [4:0] | |
| SBL_CMD_IN | Transfer command |
| SBLL_LAST_IN | Transfer end flag |
| SBL_TRID_IN [3:0] | Transaction ID |
| SBI_ADDR_IN [12:0] | Transfer address |
| SBL_DATA_IN [63:0] | Transfer data |

The signal line group 50d is an input signal and is stored in a register 510. A clockwise input signal group 511, i.e., an output of the register 510, which is delayed by one cycle, is inputted to a BID decoder 512, a selector 513, and the signal line group 50a. To the BID decoder 512, at least WE and BID among the input signal group 511 are inputted. The BID decoder 512 has a block ID [4:0] for recognizing its own block number.

FIG. 5 shows a timing chart of the clockwise shift type bus. The bus protocol of the clockwise shift type bus is described using this timing chart and the signal line groups of the shift register slot 500 of FIG. 4. In addition, the own block ID in this timing chart is “B.” If an inputted EID is not equal to the block ID and if WE is 1, the signal line group 511 is selected at the selector 513 and the signal line group 511 is outputted to the signal line group 50e. As a result, the signal line group 50d is delayed by one cycle and is outputted to the signal line group 50e, and then is inputted to a shift register slot at the next stage and is succeeded as a valid data write transaction. This protocol is the shifted data output in FIG. 5. Next, if the inputted EID is equal to the block ID and if WE is 1, the inputted EID is recognized as an input to its own block and an R_WE_IN signal of the signal line group 50a is set to 1. If this R_WE_IN signal is 1, each block recognizes that the input from the clockwise shift type bus is a data write transaction and carries out the data write processing. This protocol is the data write in FIG. 5.

Moreover, if the data write condition is satisfied, the selector 513 is selected to the input signal line group 50b side, and the input signal line group 50b is outputted to the signal line group 50e. At this time, SBR_OUT_REQ of the input signal line group 50b is outputted to SBR_WE_OUT of the input signal line group 50e. If SBR_OUT_REQ is 0, it is inputted to a shift register slot at the next stage as an invalid transaction. This protocol is the same as the data write in FIG. 5. If SBR_OUT_REQ is 1, it is inputted to the shift register slot at the next stage as a valid transaction. This is the data write & data output in FIG. 5. In addition, if the inputted WE is 0, it is recognized that an invalid transaction is inputted, and the selector 513 is selected to the input signal line group 50b side to enable a data write from its own block.

These behaviors of the BID decoder 512 enables: a behavior that an input from the signal line group 50d is received as a data write transaction; a behavior that the signal line group 50b is outputted to a shift register slot at the next stage as a data write transaction; and that a transaction is succeeded to the next stage even if the transaction is not the data write transaction to its own block. In this way, the clockwise data transfer from the left side block to the right side block is realized.

Similarly, with respect to the above description, the signal line group 50d is replaced with the signal line group 50g, the signal line group 50e is replaced with the signal line group 50f, the signal line group 50a is replaced with the signal line group 50c, the register 510 is replaced with a register 514, the BID decoder 512 is replaced with a BID decoder 516, the selector 513 is replaced with a selector 517, and the SBR_OUT_REQ signal is replaced with an SBL_OUT_REQ signal, thereby allowing a counterclockwise data transfer from the right side block to the left side block to be realized.

In addition, when a data write transaction occurred simultaneously from the signal line group 50a and the signal line group 50c to a memory with a single port memory, such as a memory, a conflict at the memory write port will occur. In order to prevent this, there are several methods. One of them is that one side of the shift type bus is stalled to prioritize a data write from one side. In this case, the conflict signal is broadcasted to all the blocks before stopping the shift type bus. Moreover, by inputting the signal line group 50a and signal line group 50c to FIFO, the frequency of the conflict can be prevented. Moreover, in the case where such a memory is used, an interleave type memory configuration is employed so that the writing from the clockwise shift type bus and the writing from the counterclockwise shift type bus may be carried out to separate bank memories, and thus the conflict can be prevented. However, the data flow is simple, and for the data delivery between blocks, the clockwise shift type bus is used, and for reading an external memory, i.e., a data write transaction via the internal bus bridge 60, the counterclockwise shift type bus is used, and thus the conflict can be prevented. Moreover, the probability that the data write transactions occur to one memory in the same cycle from the clockwise shift type bus and from the counterclockwise shift type bus and thus a conflict occur is extremely small. For this reason, the extent to which the performance decreases may be low.

With this method, the bus transfer can be achieved without having a global bus arbitration circuit which is usually timing-critical. Moreover, by being through registers in the unit of block by means of the registers 510 and 514 in the shift register slot 500, the long wirings and timing critical paths can be reduced in an actual LSI floor plan. Generally, in a tri-state bus architecture and a crossbar switch type bus, as the number of blocks increased, the critical timing and the amount of wirings will increase, however according to this method, even when the number of blocks to be connected to the bus is increased, an increase in the critical timing and the amount of wirings can be suppressed.

Moreover, the data transfer can be carried out in parallel in the same cycle between a plurality of blocks, so that a high data transfer performance can be obtained. Especially when carrying out the data transfer only to adjacent blocks, a data bandwidth in proportional to the number of blocks can be obtained. As described above, the bus protocol of the shift type bus 50 is only data writing. In the bus protocol of data write, an address (ADDR_OUT) and a data (DATA_OUT) can be outputted in the same cycle as a request signal (WE_OUT), and thus a simpler bus can be configured as compared with a bus structure in which the data write is carried out using a FIFO or a queue while holding the state.

The clock stop signal 500p is inputted to the terminal 50p. When this clock stop signal 50p is active, the signal line group 50d and signal line group 50g are selected at both selector 513 and selector 517, respectively. This allows for the through-propagation without being through the register from the input to the output. This method allows for a data transfer, for example, even when a clock for one block is stopped. Because this shift type bus 50 does not have a global bus arbitration circuit, a clock is supplied to only a block which should at least operate, thus allowing for a data transfer between blocks and reducing the number of registers to operate, so that the power consumption can be reduced. In addition, by supplying a clock to the whole shift type bus 50 and not supplying the clock to each block, each block can be also stopped with an increase in power worth of the registers 510, 514, and 518.

In this way, the shift type bus 50 allows for connection between adjacent blocks with a simple interface. Accordingly, a plurality of blocks can be connected by extending the block ID field. Although in the description of this embodiment the shift type bus 60 is described as a common bus in the picture processing part 6, the invention is not limited thereto. For example, use of the shift type bus interface at LSI pins allows for serial connection of a plurality of LSIs, so that communication not only with adjacent LSIs but also with LSIs which are distant arrangement-wise. In addition, in the inter-LSI connection, a reduction in pin counts can be also achieved using a high-speed serial interface or the like.

Moreover, the shift type bus 50 has a Last signal. If this signal line is “1” upon data transfer, a data memory ready counter DMRC in a synchronization control part 473 described later is counted up. This provides a synchronization between blocks at instruction level. The detail thereof will be described later. In addition, the shift type bus also has a read transaction. This read transaction also will be described later.

Again, the picture processing part 6 is described using FIG. 2. To the shift type bus 50 are connected a plurality of blocks. Namely, in addition to the internal bus master control part 61 and internal bus slave control part 62 shown earlier, there are connected: a shared local memory 65 having a memory which can be shared across the picture processing part 6; a plurality of picture processing engines 66 and 67 which carry out processings, such as video CODEC, rotation, scaling, and the like of images, to a two-dimensional image, the picture processing engine being operated by software; and a dedicated hardware 68 for carrying out the processing of a part of the image processings. An example of the dedicated hardware 68 is a block which processes a motion prediction, or the like, at the time of encoding in MPEG-2 or H.264 encoding standard. However, because the processing contents of the dedicated hardware 68 do not have a relationship with the essence of the present invention, the description thereof is omitted. The picture processing engines 66 and 67 are processor type blocks, and a plurality of them can be connected onto the shift type bus. The shared local memory 65, the picture processing engines 66 and 67, the dedicated hardware 68, the internal master control part 61, and the internal bus slave control part 62 each have a unique block ID and are connected to each other by a common bus protocol of the shift type bus 50.

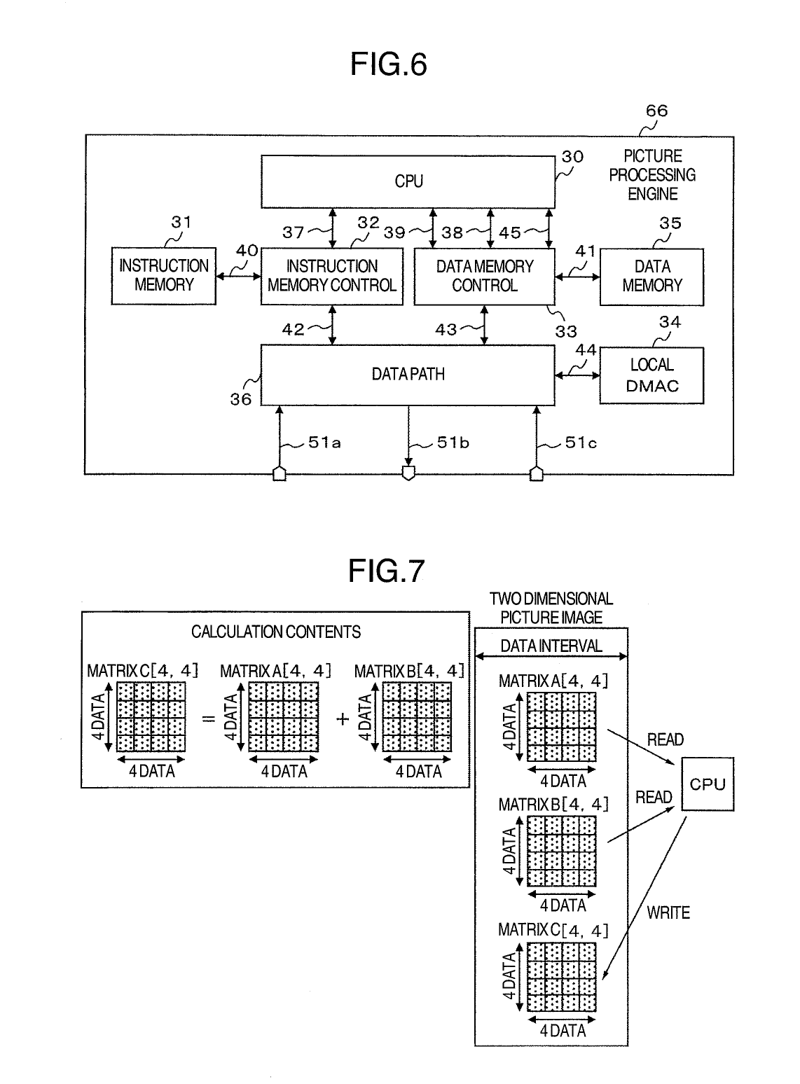

Next, the picture processing engine 66 in the first embodiment is described in more detail using FIG. 6. FIG. 6 is a block diagram of the picture processing engine 66. The interface of the picture processing engine 66 is an interface only with the shift type bus 50, i.e., the input signal 51a of the clockwise shift type bus, the input signal 51c of the counterclockwise shift type bus, and the output signal 51b with respect to the shift type bus 50. These three types of signals are connected to a data path part 36. To the data path part 36, a local DMAC 34 which carries out a data output processing to the shift type bus 50 is connected via a signal line 44.

Moreover, the picture processing engine 66 includes an instruction memory 31 and data memory 35 capable of carrying out a data write from the shift type bus 50. To the data path part 36, an instruction memory control part 32 for controlling the instruction memory 31 is connected via a path 42 and a data memory control part 33 is connected via a path 43. The instruction memory control part 32 is a block which controls a data write from the shift type bus 50 to the instruction memory 31 and controls an instruction supply to a CPU part 30, and the instruction memory control part 32 is connected to the instruction memory 31 via a path 40, to the CPU part 30 via a path 37, and to the data path part 36a via the path 42, respectively. The data memory control part 33 is a block which controls a data write from the shift type bus 50 to the data memory 35 and controls a data output from the data memory 35 to the shift type bus 50, which data output the local DMAC 34 controls. The data memory control part 33 further controls an access from the CPU 30 to the data memory 35. The control of the data memory 35 is carried out using a path 41.

The data write from the shift type bus 50 to the data memory 35 and the data output from the data memory 35 to the shift type bus 50 are controlled via the path 43 in concert with the data path part 36. The connection to the CPU part 30 is controlled by two paths. The data read processing from the data memory 35 to the CPU part 30 is controlled by a path 38, and the data write from the CPU part 30 to the data memory 35 is controlled by a path 39. In both cases, the access address of the data memory 35 is supplied via a path 45.

In addition, although in the description of this embodiment, for ease of description, the number of the data memory 35 is one, an interleave configuration using a plurality of data memories is also possible. With the interleave configuration, the access to a plurality of data memories 35 can be carried out in parallel. In prior to describing the present invention, the calculation contents by the CPU 30 are defined. However, these calculation contents are for describing the essence of the present invention, and the types of calculation contents are not limited thereto.

FIG. 7 shows an overview of the calculation contents. As shown in FIG. 7, the calculation contents are an addition of each pixel of a two-dimensional image A and each pixel of a two-dimensional image B and a writing to a memory. In the case where the SIMD type arithmetic logical unit shown in JP-A-2000-57111 is used, as for the required cycles, 4 cycles are consumed for reading Matrix A, 4 cycles for reading Matrix B, 4 cycles for addition, and 4 cycles for subtraction, and thus a total of 16 cycles is required. In addition, if the parallel number of SIMD type arithmetic logical units is set to 8, the number of cycles required for addition is 2, however, in this description, the description is made as 4-parallel SIMD type arithmetic logical units. At this time, a total number of instructions which the SIMD type arithmetic logical units require are 16 instructions which number is the same as the number of the required cycles. The implementation method of the present invention will be described using these calculation contents.

The CPU part 30 is a CPU for carrying out calculations, and the like, to the two-dimensional image. In this embodiment, for ease of description, assume that the CPU part 30 has four instructions shown below. However, the types of the instruction are for ease of description, and the instruction types are not limited thereto. However, a means to specify a register pointer and a height direction described later is the indispensable element. Let the four instructions be a branch instruction, a read instruction, a write instruction, and an add instruction. Table 8 to Table 11 show the required bit fields in the instruction format of each instruction.

TABLE 8
Instruction format of a branch instruction

| Field | Meaning of the field |
|---|---|
| Branch | Indicates that this instruction is a |
| instruction | branch instruction. |
| operation code | |
| ADDR | Branch destination address |
| CBR_IDX | Read index of a branch condition |
| | register |

TABLE 9
Instruction format of a read instruction

| Field | Meaning of the field |
|---|---|
| Read | Indicates that this instruction is a |
| instruction | read instruction. |
| operation code | |
| ADDR | Read address of the data memory 35. In |
| | this description, for ease of |
| | description, the address is specified |
| | by an immediate value indicated in the |
| | instruction itself. |
| DestReg | Register number pointer for storing a |
| | read data. The registers which can be |
| | specified are a register file space and |
| | a master S/D register. The master S/D |
| | register is arranged in the local DMAC |
| | 34 |
| Width | Width of a data to read |
| Count | Height of a data to read (number of |
| | counts) |
| Pitch | Data interval when reading a two- |
| | dimensional data |

TABLE 10
Instruction format of a write instruction

| Field | Meaning of the field |
|---|---|
| Write | Indicates that this instruction is a |
| instruction | write instruction. |
| operation code | |
| ADDR | Write address of the data memory 35. |
| | In this description, for ease of |
| | description, the address is specified |
| | by an immediate value indicated in the |
| | instruction itself. |
| SrcReg | Register number pointer in which a |
| | write data is stored. |
| Width | Width of a data to write |
| Count | Height of a data to write (number of |
| | counts) |
| Pitch | Data interval when writing a two- |
| | dimensional data |

TABLE 11
Divide-add instruction format

| Field | Meaning of the field |
|---|---|
| Divide-add | Indicates that this instruction is a |
| instruction | divide-add instruction. |
| operation code | |
| SrcIReg | First register number pointer in which |
| | a source data is stored. |
| Src2Reg | Second register number pointer in which |
| | the source data is stored. |
| DestReg | Register number pointer for storing a |
| | calculation result. |
| Width | Width of a data to which a divide-add |
| | operation is carried out (number of |
| | bytes). |
| Count | Height of a data to which a divide-add |
| | operation is carried out (number of |
| | counts). |

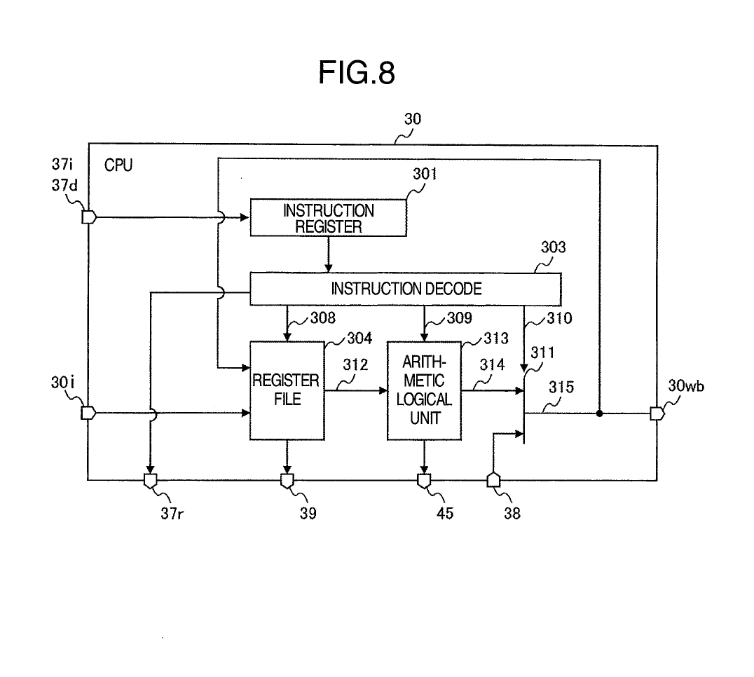

FIG. 8 is a block diagram of the CPU part 30. The interface 37 with the instruction memory control part 32 is divided into two types of signals, one of which is an instruction fetch request 37r which an instruction decode part 303 outputs to the instruction memory control part 32, and the other one is an instruction 37i which the instruction memory control part 32 outputs and which is inputted to the CPU part 30. The instruction decode part 303 outputs the instruction fetch request 37r at the time when one instruction processing is terminated. Correspondingly, the instruction 37i and an instruction ready signal 37d are inputted and stored in an instruction register 301. In the description here, the description is made assuming that the number of sets of the instruction register 301 is one. However, because a read latency of an instruction is greater than one cycle, it is also possible to have a plurality of sets of instruction registers 301. A value of the instruction register 301 is supplied to the instruction decode part 303 to decode the instruction. The instruction decode part 303 generates a control line 308 for controlling a read port and a write port of a register file (general-purpose register) 304, an instruction decode signal 309 for controlling an arithmetic logical unit 313, and a control line 310 for controlling a selector 311 depending on the types of an instruction. Moreover, the instruction fetch request 37r is outputted at the time when one instruction processing is terminated.

Here, the CPU part 30 is described as having a read instruction, a write instruction, and a divide-add instruction, except for a branch instruction. Accordingly, during a read instruction, at the time when a read data 38 is returned, the control line 308 uses a register number pointer value, in which register a read data is stored, as a storage location register number pointer. During a write instruction, a write data register number is used because reading the register file 304 is required. During a divide-add instruction, both reading and writing to the register file 304 are required and thus these are controlled. Although in this description the instruction decode signal 309 becomes active only during the divide-add instruction, in case of having other instructions a signal for controlling the arithmetic logical unit is outputted in accordance with the type of the instruction. The control line 310 selects the read data 38 at the time of a read instruction, and selects a calculation result 314 of the arithmetic logical unit 313 at the time of a divide-add instruction. A selected calculation data 315 is stored in the register file 304. Moreover, at the time of a read instruction and at the time of a write instruction, the instruction decode part 303 controls the arithmetic logical unit 313 to generate an access address 45 of the data memory 35.

In addition, the arithmetic logical unit 303 consists of 8-parallel SIMD type arithmetic logical units like in JP-A-2000-57111, where eight 8-bit width additions can be executed in parallel. That is, eight divide-add operations can be executed in parallel. Moreover, the data width of the CPU 30 is set to 8 bytes. Accordingly, a read instruction, a write instruction, and a divide-add instruction can be executed in the unit of 8 bytes. Moreover, assume that 8, 16, and 32 can be defined in the width field of a read instruction, a write instruction, and a divide-add instruction, and in the count field, 1 to 16 can be specified at an interval of one.

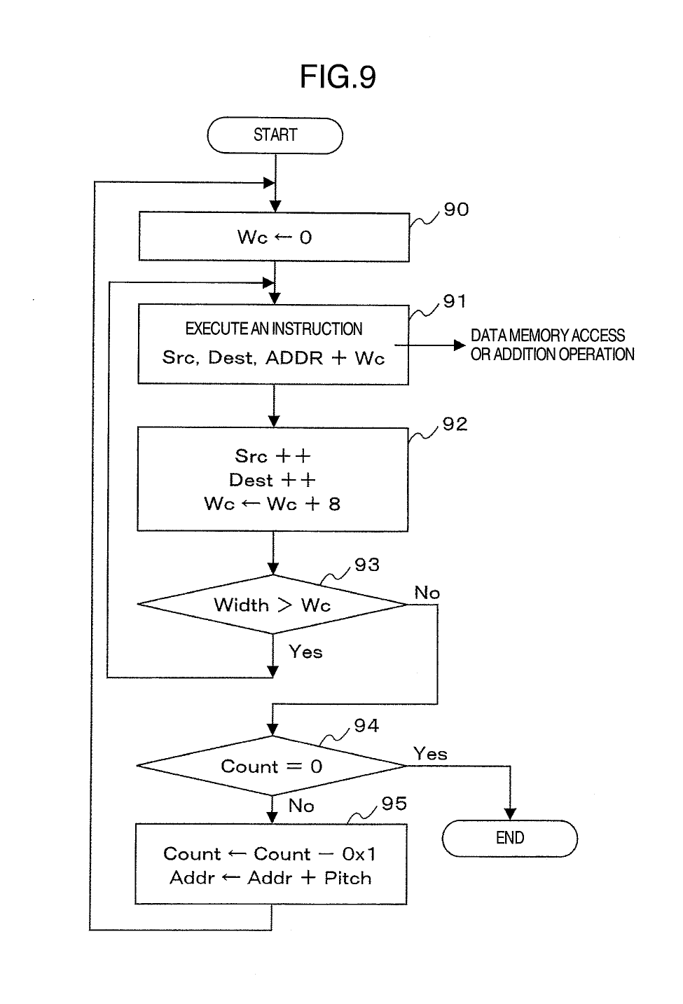

The operation of generating the access address 45 of the instruction decode part 303 and arithmetic logical unit 313 is described using FIG. 9. FIG. 9 is a flowchart for generating the control line 308, which controls the read port and write port of the register file 304 and which the instruction decode part 303 generates, and for generating the access address 45 of the data memory 35.

The instruction decode part 303 includes a Wc counter, which is cleared to 0 upon activation of an instruction (Step 90). Next, in Step 91, a read instruction, a write instruction, and a divide-add instruction are executed using Src and Dest, and (Addr+Wc). Next, in Step 92, one is added to Src and Dest, and 8 is added to Wc. In Step 93, the Width field specified in the instruction field is compared with Wc. If Width is greater than Wc, the flow returns to Step 91 again to repeat the instruction execution. If Width is equal to or smaller than Wc, the flow changes to Step 94 to determine whether the Count value shown in the instruction field is 0 or not. If the Count value is not 0, the flow changes to Step 95, where one is subtracted from the Count value and Pitch is added to Addr, and again the flow changes to Step 90 to repeat the instruction execution. If the Count value is 0, the instruction execution is terminated. At this time, the instruction decode part 303 outputs the instruction fetch request 37r.

The behavior of the flowchart of FIG. 9 allows a calculation to a two-dimensional rectangular to be carried out using one instruction. Especially in a read instruction, by specifying Pitch, a two-dimensional rectangular which is dispersively arranged on the data memory 35 can be stored in the register file 304 as a continuous data. Moreover, in a write instruction, similarly by specifying Pitch, the continuous data arranged on the register file can be written to a two-dimensional rectangular area which are dispersively arranged on the data memory 35.

In the calculation contents shown in FIG. 7, the calculation can be completed only with a total of four instructions, i.e., two read instructions, one divide-add instruction, and one write instruction. Namely, from the instruction memory 31 only four instructions just need to be fetched. However, in contrast to the instruction length of the SIMD type shown in JP-A-2000-57111, in the instruction of the present invention the operands, such as Width, Count, and Pitch, are added to thus increase the instruction length. Assume that the instruction width of JP-A-2000-57111 is of 32 bits, then the instruction length in the present invention is in the order of 64 bits. Although the power consumed in one instruction memory access is doubled, the access frequency can be reduced from 16 to 4 and thus a total power consumption which the instruction memory consumes is expressed by 2× 4/16, so that the power can be cut in half. Moreover, carrying out a processing to the two-dimensional data with one instruction substantially reduces the number of times of loops caused by the same instruction of a program. This means that the capacity of the instruction memory 31 can be reduced.

In addition, in FIG. 8, an input data 30i is inputted to the register file 304 and can update the data of the register file 304. Moreover, the calculation data 315 is outputted as a calculation data 30wb. These input data 30i and calculation data 30wb will be described in a second embodiment.

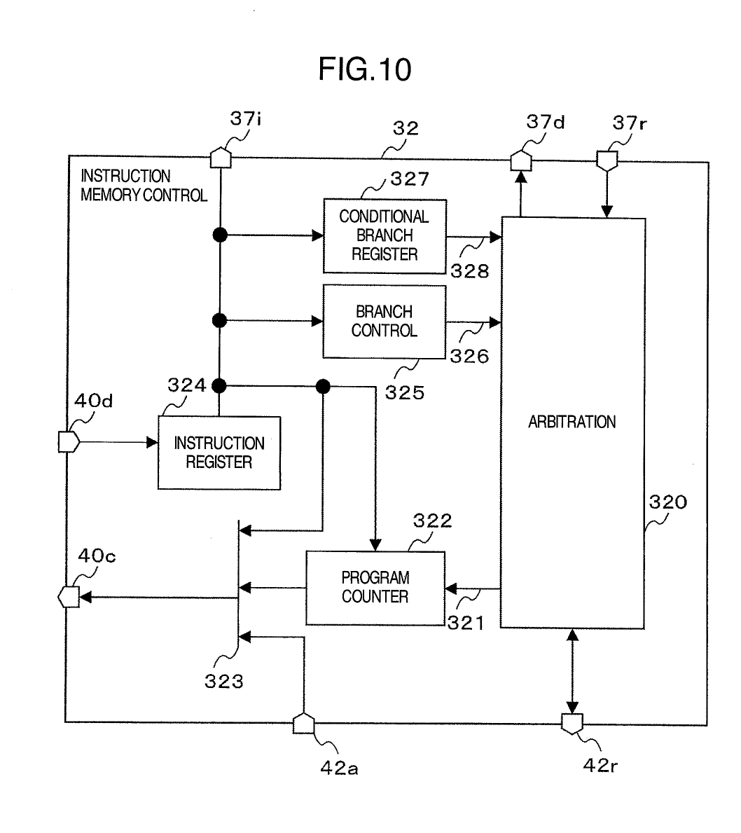

The instruction memory control part 32 in the first embodiment is described using FIG. 10. FIG. 10 is a block diagram of the instruction memory control part 32. The instruction memory control part 32 is a block for controlling a memory access of the instruction memory 31. To the instruction memory 31, an instruction fetch access from the CPU part 30 and an access from the shift type bus 50 are carried out, and the instruction memory control part 32 arbitrates these accesses to allow an access to the instruction memory 31. The access arbitration is carried out in an arbitration part 320. The memory access requests are the instruction fetch request 37r inputted from the CPU part 30 and the path 42 inputted from the data path part 36. Depending on the arbitration result, a selector 323 is controlled to output the control line 40c, such as an address for accessing to the instruction memory 31.

In case of an instruction fetch access, the arbitration part 320 causes the selector 323 to select an output of an instruction program counter 322 for reading the instruction memory 31, and outputs a control line 321 to increment the program counter 322. An instruction 40d returned from the instruction memory 31 is stored in an instruction register 324 and is returned to the CPU part 30 as the instruction 37i. At the same time, the operation code field of the instruction is inputted to a branch control part 325, where whether it is a branch instruction or not is determined and a signal 326 which is set to 1 at the time of a branch instruction is inputted to the arbitration part 320. Moreover, a read index field of the instruction register is inputted to a branch condition register 327. The branch condition register 327 is a group of registers consisting of a plurality of one bit width words, and the word is specifies by a read index field of the branch condition register, and a signal 328 with one bit width is inputted to the arbitration part 320.

The actual branching occurs if the signal 326 is 1 and if the signal 328 is 1. The combinations other than this are recognized as instructions other than the branch instruction. The arbitration part 320 returns the instruction ready signal 37d only at the time of instructions other than the branch instruction. At the time of the branch instruction, the instruction ready signal 37d is not returned, and the selector 323 selects an immediate value stored in the instruction register 324. At this time, the program counter 322 is updated with a value incremented by this immediate value.

According to this method, when an interval of issuing the instruction fetch request 37r of the CPU takes several cycles, the cycles which it takes to re-read the instruction due to a branch instruction can be masked completely, so that the performance decrease due to the branching can be suppressed. In the CPU part 30 in the present invention, a two-dimensional operand is specified, so that the pitch of issuing the instruction fetch request 37r is large and thus the above-described advantage is significant.

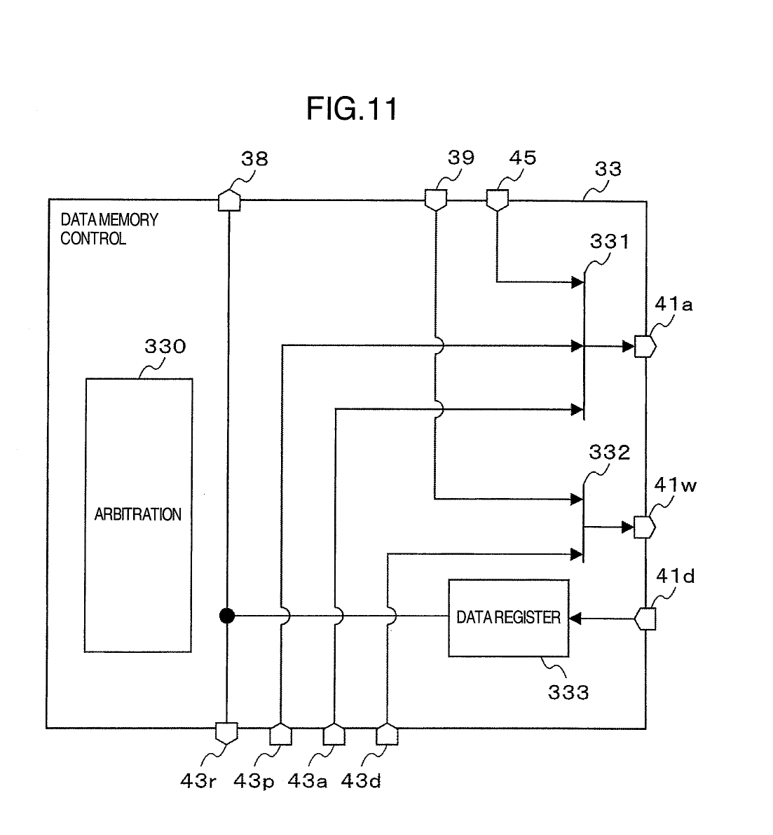

The data memory control part 33 in the first embodiment is described using FIG. 11. FIG. 11 is a block diagram of the data memory control part 33. To the data memory 35, the read and write accesses from the CPU part 30, the write processing from the shift type bus 50, and the read access from the local DMAC 34 can be carried out, and the data memory control part 33 is a block for arbitrating these accesses. The arbitration is carried out in an arbitration part 330, where an address selector 331 and a data selector 332 are controlled. In addition, the signal line 41 between the data memory 35 is grouped into three signal lines, 41a, 41d, and 41w. Moreover, the signal line 43 between the data path part 36 is grouped into four signal lines, i.e., signal lines 43a, 43d, 43p, and 43r.

First, connection to the CPU part 30 is described. The data memory address 45 at the time of a read instruction and write instruction is through the address selector 331 and is inputted to the data memory 35 as the data memory address 41a. At the time of a write instruction, the write data 39 is inputted to the data memory 35 via a data selector 332 as the write data 41w. At the time of a read instruction, in accordance with the data memory address 41a the read data 41d is read and stored in a data register 333. The stored read data is returned to the CPU part 30 as the read data 38. In addition, if a value of the master S/D register is specified in DestReg of a read instruction, the read data is outputted to the read data 43r. Next, in a write processing from the shift type bus 50, the address line 43a is through the address selector 331 and is inputted to the data memory 35 as the data memory address 41a. At the same time, the data line 43d is inputted to the data memory 35 via the data selector 332 as the write data 41w.

Finally, at the time of access from the local DMAC 34, the address 43p is through the address selector 331 and is inputted to the data memory 35 as the data memory address 41a. The read data 41d read correspondingly is stored in the data register 333 and is returned as the read data 43r.

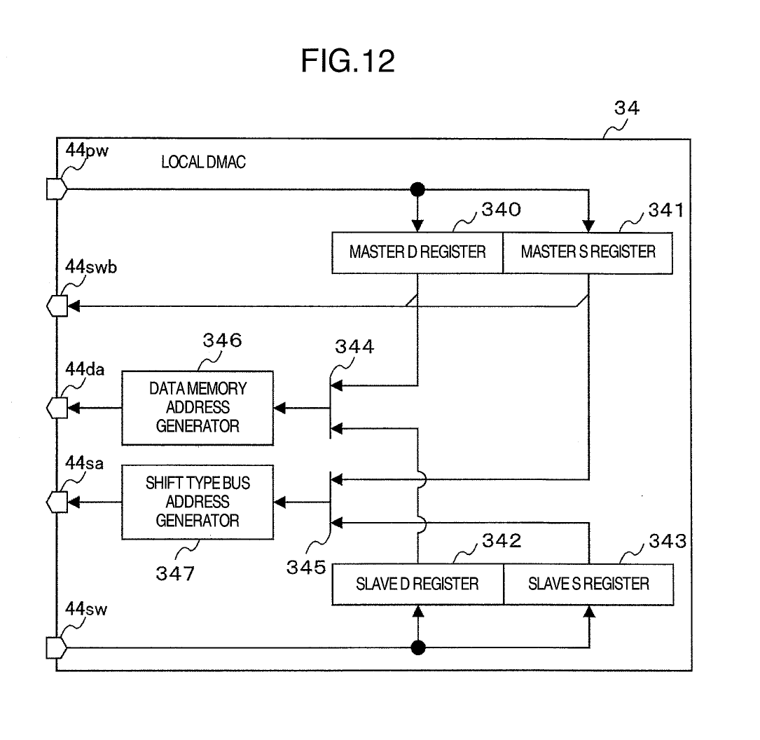

The local DMAC 34 in the first embodiment is described using FIG. 12. FIG. 12 is a block diagram of the local DMAC 34. The local DMAC 34 has: a function to generate a data memory address 44da in the process of outputting a data to the shift type bus 50 as well as the data memory address 44da for carrying out a read processing corresponding to a read access from the data memory 35 inputted from the shift type bus 50; a function to generate a shift type bus address 44sa at the time of outputting a data to the shift type bus 50; and a function to generate a read command to the shift type bus 50. To the local DMAC 34, only the data path part 36 is connected by the signal line 44. Here, the signal line 44 can be grouped into five types of signal lines, i.e., signal lines 44pw, 44swb, 44da, 44sa, and 44dw.

The local DMAC 34 includes four sets of register groups, i.e., a master D register 340 and master S register 341 which can be rewritten by a read instruction, and a slave D register 342 and slave S register 343 which can be written from the shift type bus 50. Table 12 to Table 15 show the format of each register.

TABLE 12
Format of the master D register 340

| Field | Meaning of the field |
|---|---|
| Mode | Operation mode in a pair of master D |
| | register and master S register is |
| | specified. Value 0: data write mode, Value |
| | 1: read command mode. |
| MDIR | Specifies whether to use the clockwise |
| | shift type bus or to use the |
| | counterclockwise shift type bus in data |
| | transferring at the time of data output or |
| | at the time of data read. Value 0: use the |
| | counterclockwise shift type bus, Value 1: |
| | use the clockwise shift type bus. |
| MBID | Specifies the bock ID of a picture |
| | processing engine to read. This value is |
| | not used at the time of a write mode. |
| MADDR | Specifies the access address of the data |
| | memory 35 to read. |
| MWidth | Specifies the width of a data to read. |
| MCount | Specifies the height of a data to read. |
| MPitch | Specifies the interval of a data to read. |
| Last | Specifies whether or not to set a Last |
| | signal of the shift type bus interface at |
| | the time of transferring a final data. |

TABLE 13
Format of the master S register 341

| Field | Meaning of the field |
|---|---|
| SBID | Specifies the block ID of a picture |
| | processing engine to write. Specifies its |
| | own block ID at the time of a write mode. |
| | Specifies the block ID of a returning |
| | destination block of a read data at the |
| | time of a read command. |
| SBIDMsk | Specifies a comparison mask of the block ID |
| | of a picture processing engine to write. |
| | The comparison of the block ID is carried |
| | out only to a field in which this value is |
| | “0”. However, this values is always |
| | specified to “0” at the time of read. |
| SDIR | Specifies whether to use the |
| | counterclockwise shift type bus or to use |
| | the clockwise shift type bus in a data read |
| | command mode. Value 0: use the |
| | counterclockwise shift type bus, Value 1: |
| | use the clockwise shift type bus. |
| SADDR | Specifies the access address of the data |
| | memory 35 to write. |
| SWidth | Specifies the width of a data to write. |
| SCount | Specifies the height of a data to write. |
| SPitch | Specifies the interval of a data to write. |

TABLE 14
Format of the slave D register 342

| Field | Meaning of the field |
|---|---|
| VALID | Indicates whether a data read is running or |
| | not. Value 0: invalid, Value 1: valid. |
| MDIR | Specifies whether to use the |
| | counterclockwise shift type bus or to use |
| | the clockwise shift type bus in |
| | transferring a data at the time of data |
| | read. Value 0: use the counterclockwise |
| | shift type bus, Value 1: use the clockwise |
| | shift type bus. |
| MADDR | Specifies the access address of the data |
| | memory 35 to read. |
| MWidth | Specifies the width of a data to read. |
| MCount | Specifies the height of a data to read. |
| MPitch | Specifies the interval of a data to read. |
| Last | Specifies whether or not to use a Last |
| | signal of the shift type bus interface at |
| | the time of transferring a last data. |

TABLE 15
Format of the slave S register 343

| Field | Meaning of the field |
|---|---|
| SBID | Specifies the bock ID of a picture |
| | processing engine to write. Usually, this |
| | field to be used at the time of a data read |
| | is the block ID of a picture processing |
| | engine which issued the data read command. |
| | However, if a different block ID is |
| | specified in advance, the data is returned |
| | to a picture processing engine or the like |
| | having this block ID. |
| SADDR | Specifies the access address of the data |
| | memory 35 to write. |
| SWidth | Specifies the width of a data to write. |
| SCount | Specifies the height of a data to write. |
| SPitch | Specifies the interval of a data to write. |

The data transfer using the local DMAC 34 has three types of operation modes.

The first one is a data write mode. The data write mode is a mode in which its own data memory 35 is read using a parameter of the master D register 340, and the data is transferred to a block of other picture processing engine or the like using a parameter of the master S register 341 and the data is written to an address-mapped region of the data memory 35 or the like.

The second one is a read command mode. The read command mode is a processing in which the values themselves of the master D register and the master S register are transferred to a block of other picture processing engine or the like, as the data, and the values are stored in the slave D register and the slave S register of the other block. This operates as a read request to other block. In addition, at the time of a read command mode, as an interface of the shift type bus 50, a CMD signal is set to 1 for transferring. A block which receives a read command recognizes based on the CMD signal whether or not this shift type bus transfer is a read command or not.

The third one is a read mode. This is a mode in which in response to the read request received in the above-described read command mode, the data memory 35 is read using a parameter of the slave D register 342, and the data is transferred to a block, such as other picture processing engine, using a parameter of the slave S register 343, and the data is stored in a address-mapped region of the data memory 35, or the like. With a combination of these three modes, a data transfer is achieved between blocks, such as the picture processing engines, or the like

The master D register 340 and master S register 341 can be updated by a read instruction issued by the CPU part 30, and at this time, a data is inputted from the signal line 44pw to thereby update two registers. That is, a descriptor, in which the contents of data transfer is described, is stored in the data memory 35 in advance, and the data transfer is started by copying the contents to the master D register 340 and the master S register 341.

Upon update of the two registers, the state changes to two states depending on the Mode field of the master D register 340. If the Mode field indicates a data write mode, MADDR, MWidth, MCount, and MPitch of the master D register 340 are transferred to a data memory address generator 346 via an address selector 344. The data memory address generator 346 generates an address for reading the data memory 35, and outputs the address 44da. The address is generated by the same method as the access address 45 which the instruction decode part 303 in the CPU part 30 generates. Accordingly, the data memory address generator 346 has a Wc counter, where a two-dimensional rectangular address is generated by an address generation replacing MWidth, MCount, and MPitch with Width, Count, and Pitch, respectively.

In the same way, SADDR, SWidth, SCount, and SPitch of the master S register 341 are inputted to a shift type bus address generator 347 via an address selector 345, where an address to be outputted to the shift type bus 50 is generated, thereby outputting the address 44sa. The address generation by this shift type bus address generator 347 also expresses a two-dimensional rectangular like in the address generation of the data memory address generator 346. With these two addresses, the read data 43r is read from the data memory 35 sequentially, so that a data write processing is achieved from the picture processing engine 66 to the shift type bus 50, as the signal line group 50b. At this time, the destination block is a block which the field SBID of the master S register 341 indicates. At this time, whether to use the counterclockwise shift type bus or to use the clockwise shift type bus is determined in accordance with a MDIR flag.

In addition, in this method, the address 44da of the data memory 35 and the address 44sa for outputting to the shift type bus are generated using MWidth, MCount, MPitch, and SWidth, SCount, SPitch, respectively. In this way, the address generation by two sets of registers each allows the shape of a two-dimensional rectangular to be converted, thus allowing for data transfer. However, when transferring as the same rectangular, the address can be generated by the parameter of only one of the registers.

On the other hand, when the Mode field indicates a read command mode, the values of the master D register 340 and master S register 341 are outputted as the direct output signal 44swb to thereby transfer the read command to other block. At this time, the destination block is a block which the MBID field of the master D register 340 indicates. When the destination block received this read command, the slave D register 342 and slave S register 343 are updated to start the processing as a read mode. The read command is through the path 44sw and is updated in the slave D register 342 and slave S register 343. After the destination block receives the read command, the read data is read and outputted to the shift type bus 50 by almost the same operation as that of the above-described data write processing. MADDR, MWidth, MCount, and MPitch of the slave D register 342 are inputted to the data memory address generator 346 via the address selector 344 to access the data memory 35 as the address 44da. Subsequent behavior is the same as the one at the time of data write. In the same way, SADDR, SWidth, SCount, and SPitch of the slave S register 343 are inputted to the shift type bus address generator 347 via the selector 345, where the address 44sa is generated. Subsequent operation is the same as the one at the time of data write. With these three behaviors of the local DMAC 34, in the shift type bus 50 the data transfer is achieved with only a write transaction in which an address and a data can be outputted in the same cycle. Generally, in order to improve the performance of a bus, a split type bus is used in which an address and a data are separated to each other. In the split type bus, an address and a data are managed by ID, such as the same transaction ID, and a slave side of each request queues the address into FIFO or the like and waits until receiving a data. Accordingly, the bus performance is limited by the number of stages of the queue or FIFO. On the other hand, in this method, in every bus transfer, an address and a data can be transferred in the same cycle and thus the saturation of the performance due to the number of stages of FIFO or the like will not occur.

In addition, the operation of the local DMAC 34 is activated by a read instruction, and upon this activation, the CPU part 30 can execution the next instruction. However, only during transfer execution using the local DMAC 34, the use of next local DMAC 34 is prohibited and is stalled However, the performance decrease due to conflict will not occur by increasing the pitch of issuing an activation of the local DMAC 34. Meanwhile, the CPU part 30 executes other processing sequence and thus the processing of the CPU part 30 and an interblock transfer can be executed in parallel, allowing the required number of processing cycles to be reduced. Moreover, concerning a read transfer, the receipt of the next read command is prohibited and the termination is not executed on the shift type bus 50 during execution of a read processing because the local DMAC includes only one set of slave D register 342 and slave S register 343. The shift type bus 50 is loop-shaped, and thus a restart of the read command is enabled by receiving a read command at the time when the read command circled the shift type bus 50. By carrying out most of the data transfer between blocks in a write mode and thus suppressing the generation frequency of a read, this performance decrease can be reduced. Because the picture processing involves a lot of data flow-like behaviors and the interblock transfer mostly uses a write mode, this method can suppress the performance decrease.

In transferring by means of the local DMAC 34, a “Last” signal can be outputted to the shift type bus 50. Namely, at the time of transferring while the Last field in the master D register 340 or the slave D register 342 is “1”, only one cycle is asserted at the time of the last transfer in transferring a two-dimensional rectangular. Accordingly, whether the direct memory transfer of interest is completed or not can be recognized. This is used at the time of interblock synchronization described later.

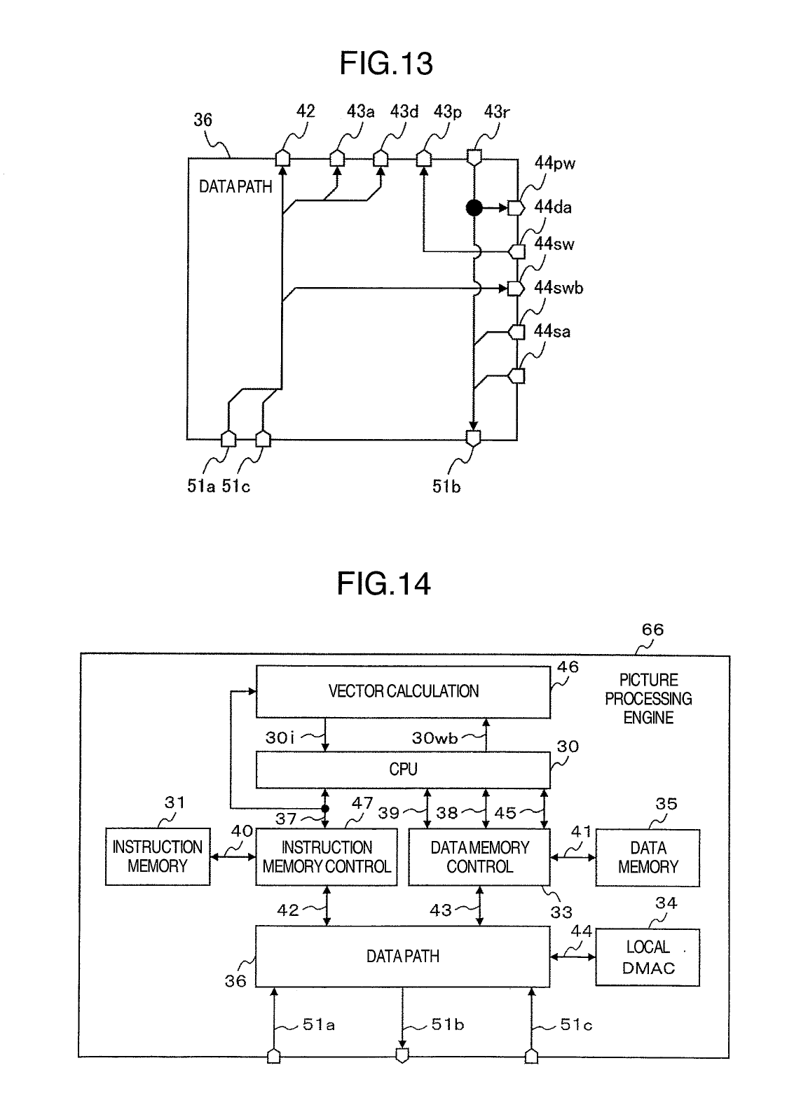

The data path part 36 in the first embodiment is described using FIG. 13. FIG. 13 is a block diagram of the data path part 36. The data path part 36 is a block which carries out data delivery between the shift type bus 50, and the instruction memory control part 32, data memory control part 33 and local DMAC 34. First, the data input from the shift type bus part 50 is described. The signal line group 51a which is an input of the clockwise shift type bus, and the signal line group 51c which is an input of the counterclockwise shift type bus are connected to the path 42, which is a write path to the instruction memory 31, and to a write path to the data memory 35, i.e., the path 43a which is an address and to the path 43d which is a data. The signal line group 51a and the signal line group 51c are further connected to the path 44sw, which is a write path to the slave D register 342 and slave S register 343 in the local DMAC 34. The signal line group 51b, which is a data output to the shift type bus 50, is inputted from two blocks. The first one is the read data 43r from the data memory 35, and the second one is the output from the local DMAC 34, i.e., the direct output signal 44swb of the master D register 340 and master S register 341, and the output address 44sa to the shift type bus 50. These are processed exclusively and controlled by a protocol of the shift type bus 50. Moreover, the address 44da, which the local DMAC 34 uses to read the data memory 35, is connected to the address 43p of the data memory control part 33.

In this way, according to the first embodiment, the power consumption can be reduced by reducing the frequency of access to the instruction memory 31 and stopping the clock supply to each block, and the like. Moreover, by means of masking in the branch instruction and the operation in parallel with the local DMAC 34, and the like, the number of processing cycles is substantially reduced to achieve a reduction in power consumption.

### Embodiment 2

A second embodiment of the present invention is described using FIG. 14. FIG. 14 is a block diagram of the picture processing engine 66 in this embodiment. There are three differences from the picture processing engine 66 of the first embodiment shown in FIG. 6. The first one is that the input data 30i and the calculation data 30wb of the CPU part 30 are connected to a vector calculation part 46. The input data 30i is a data to be inputted to the register file 304 in the CPU part 30 and can update the data of the register file 304. The calculation data 30wb is a calculation result of the CPU part 30 and is inputted to the vector calculation part 46. The second one is that an instruction memory control part 47 in place of the instruction memory control part 32 of FIG. 6 is connected. The instruction memory control part 47 has a plurality of program counters and controls the instruction memory 31. In conjunction with this, the third difference is that the vector calculation part 46 is connected to the instruction memory control part 47 via the path 37.

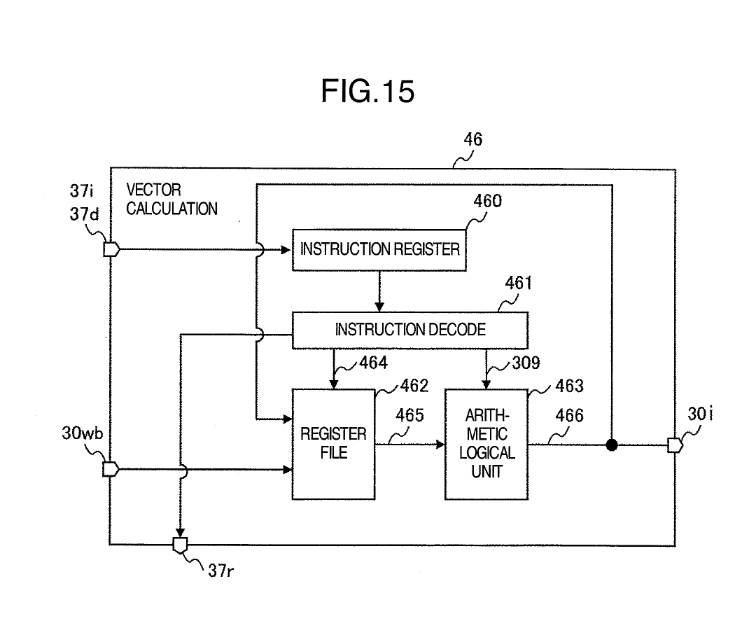

FIG. 15 is a block diagram of the vector calculation part 46 in the second embodiment. The vector calculation part 46 is not capable of accessing to the data memory 35 in contrast to the CPU part 30 shown in FIG. 8. The difference in the interfaces is that the path 38, path 39, and path 45 do not exist. In addition, an arithmetic logical unit 463 may have the same configuration as that of the arithmetic logical unit 313 of FIG. 8, or the instruction set thereof may differ. The calculation contents of the vector calculation part 46 will be described later using FIG. 21 to FIG. 26.

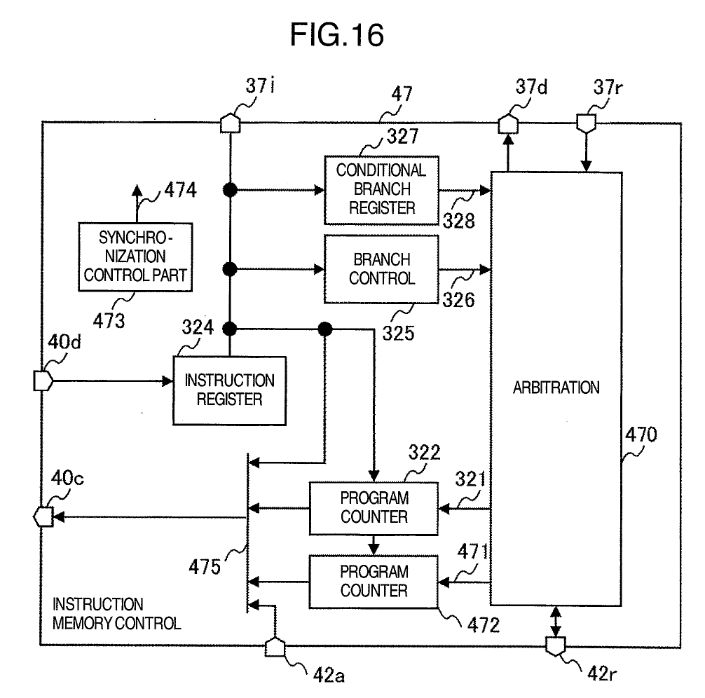

FIG. 16 shows a block diagram of the instruction memory control part 47. There are two differences between the instruction memory control part 47 and the instruction memory control part 32 shown in FIG. 10. The first one is an arbitration part 470, which receives two instruction fetch requests 37r from the CPU part 30 and from the vector calculation part 46 and arbitrates them. An arbitration result 471 is inputted to a program counter 472 directed for the vector calculation part 46. Moreover, a selector 475 is controlled to output the control line 40c, such as an address for accessing to the instruction memory 31. In this way, from the instruction memory 31 two instruction sequences of the CPU are stored, and the instruction memory 31 can be shared. In the description of the first embodiment, it is stated that with this method the interval of issuing an instruction fetch can be increased. Accordingly, even when a plurality of CPUs accessed to the shared instruction memory 31, the frequency that an access conflict occurs is low and thus the performance decrease can be suppressed. The second difference is a synchronization control part 473. The synchronization control part 473 is a block for carrying out a synchronization processing between the CPU part 30 and the vector calculation part 46, and generates a stall signal 474 to each CPU.

In the descriptions of FIG. 14 and FIG. 15, there was shown that the calculation results of the CPU part 30 and vector calculation part 46 can be stored in the register files 304 and 462 of the counterpart, respectively. The synchronization control has two modes, one of which is a synchronization indicating whether an input data is ready or not. For example, at the time when the calculation data 30wb of the CPU part 30 becomes valid, the vector calculation part 46 can use this calculation data 30wb. Accordingly, the vector calculation part 46 should be stalled until the calculation data 30wb becomes valid. This is called the input synchronization. The second one is a synchronization for determining whether the register file of a write destination is in a writable state or not. For example, the CPU part 30 should be stalled until the register file 462 of the vector calculation part 46 becomes writable. This is called the output synchronization.

Moreover, when a data is direct memory transferred from other picture processing engine 6 to the data memory 35 by using the local DMAC 34 and then the CPU part 30 reads this transfer data, it should be recognized that this direct memory transfer is completed. If the data transfer is not completed, the CPU part 30 is stalled. This is called the interblock synchronization. In addition, although the interblock synchronization can be used also in the first embodiment, the description is made only with this second embodiment. The synchronization control part 473 carries out these three synchronization processings. Next, the synchronization control method is described. In the synchronization control, the synchronization is carried out by means of four counters to be arranged for each CPU, two counters to be arranged as one pair in a block, and five flags defined on an instruction. Table 16 shows the definition of the counters. Moreover, Table 17 shows the definition of a synchronization field to be arranged in an instruction.

TABLE 16
Definition of the synchronization counters

| Counter name | Contents |
|---|---|
| SRC (slave | A counter which counts the number of |
| request counter) | times that the input synchronization |
| | is carried out. |
| ERC (execution | A counter to be counted up when a data |
| ready counter) | which a CPU at the subsequent stage |
| | uses becomes available. |
| MRC (master | A counter which counts the number of |
| request counter) | times that the output synchronization |
| | is carried out. |
| RFRC (register | A counter which indicates how much |
| file ready | free space remains in a register file. |
| counter) | |
| DARC (data | A counter which counts the number of |
| memory access | times that the interblock |
| request counter) | synchronization is carried out. |
| DMRC (data | A counter which counts the number of |
| memory ready | times that a write by direct memory |
| counter) | access is carried out to the data |
| | memory 35 from other engine. |

TABLE 17
Synchronization field in an instruction

| Field | Meaning of the field |
|---|---|
| ISYNC (input | If this field is “1” in an |
| synchronization | instruction requiring an input |
| enable flag) | synchronization, the input |
| | synchronization processing is carried |
| | out. If this field is “0”, an input |
| | synchronization is not carried out |
| | but the instruction is executed. As |
| | soon as executable by the input |
| | synchronization, the slave request |
| | counter SRC is counted up. |
| DRE (data ready | If this field is “1”, at the end of |
| enable flag) | instruction execution the execution |
| | ready counter ERC arranged in the |
| | next stage block is counted up. |
| OSYNC (output | If this field is “1” in an |
| synchronization | instruction requiring an output |
| enable flag) | synchronization, the output |
| | synchronization processing is carried |
| | out. If this field is “0”, an output |
| | synchronization is not carried out |
| | but the instruction is executed. At |
| | the end of an instruction requiring |
| | the output synchronization, the |
| | master request counter MRC is counted |
| | up. |
| RFR (register | If this field is “1”, at the end of |
| file ready flag) | an instruction a register file ready |
| | counter, which counts how much free |
| | space remains in a register file of |
| | its own block, the register file |
| | ready counter being arranged in a |
| | block at the preceding stage, is |
| | counted up. |
| MSYNC | A field which controls a block |
| | synchronization processing between |
| | information processing engines, and |
| | only a read instruction has this |
| | field. If this field is “1”, a |
| | synchronization processing between |
| | information processing engines is |
| | carried out. As soon as executable |
| | by an interblock synchronization, a |
| | data access request counter DARC is |
| | counted up. |

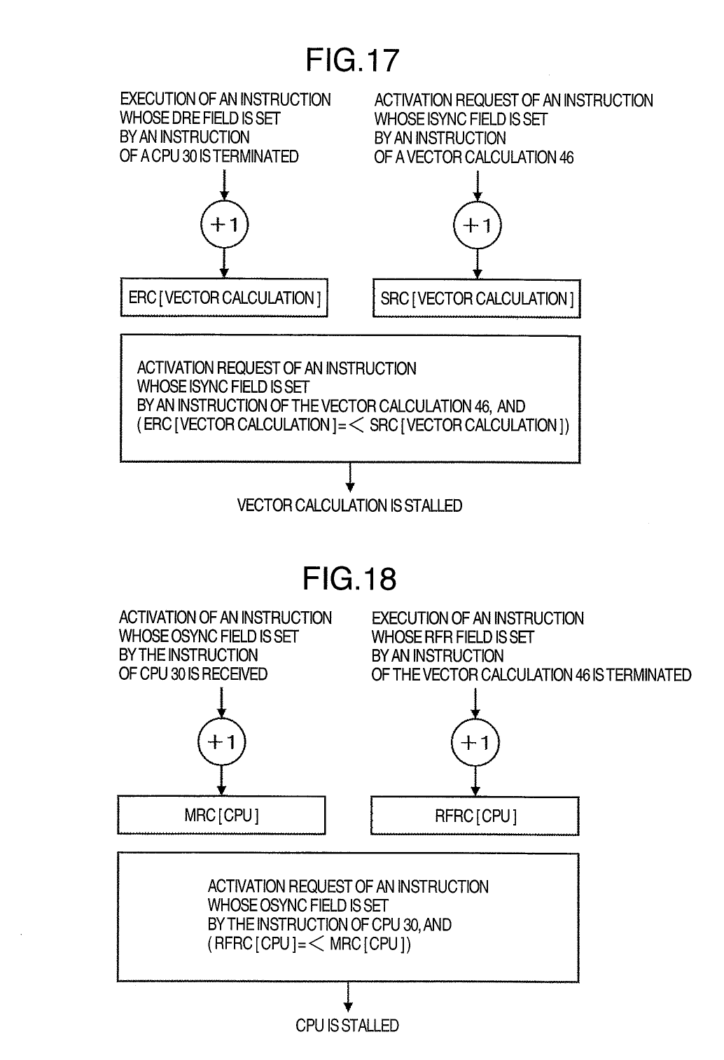

First, the input synchronization is described using FIG. 17. At the time when the calculation data 30wb of the CPU part 30 becomes valid, the vector calculation part 46 can use this calculation data 30wb. Accordingly, the vector calculation part 46 needs to be stalled until the calculation data 30wb becomes valid. At the time when an instruction whose DRE field is 1 is terminated by an instruction of the CPU part 30, the execution ready counter ERC [vector calculation part 46] in the vector calculation part 46 is counted up. The calculation data 30wb is stored in the vector calculation part 46 by this instruction, and at the end of this instruction the vector calculation part 46 can execute a calculation using the data 30wb. By that time, an instruction with ISYNC in the vector calculation part 46 is stalled. This stall condition of the instruction with ISYNC is when ERC [vector calculation part 46] is smaller than or equal to SRC [vector calculation part 46]. At the time when the above-described execution ready counter ERC [vector calculation part 46] is counted up, the execution ready counter ERC [vector calculation part 46] becomes greater than the slave request counter SRC [vector calculation part 46]. At this point, the vector calculation part 46 can release the stall and start the calculation. At the same time the slave request counter SRC [vector calculation part 46] is counted up. With one set of updates of these two counters, one input synchronization is carried out.

Moreover, even when the processing speed of the vector calculation part 46 is slow and there is a difference between the count-up of SRC and the count-up of ERC, the preparation of the calculation data 30wb by the CPU part 30, i.e., the count-up of the execution ready counter ERC, is possible and thus can operate as a data pre-fetch.

In the same way, when the CPU part 30 uses the calculation data 30i which the vector calculation part 46 generated, as opposed to the above description the DRE field is used by an instruction of the vector calculation part 46, and the ISYNC field is used by an instruction of the CPU part 30, and by means of the execution ready counter ERC [CPU part 30] and slave request counter SRC [CPU part 30] arranged in the CPU part 30, the input synchronization is enabled. In addition, although the input synchronization using the execution ready counter ERC and slave request counter SRC has been described here, the input synchronization is possible even with one bit width flag. For example, the flag is set based on the update condition of the execution ready counter ERC. Until this flag and the ISYNC flag of a CPU instruction at the receiving side of a calculation data both are set to 1, two CPUs are stalled. By clearing the flag at the time when the stall is released, a synchronization between two CPUs is enabled with few logic circuits.

Next, the output synchronization is described using FIG. 18. The output synchronization is also carried out by two counters and the synchronization fields defined in two instructions, like in the input synchronization. The output synchronization is a synchronization for recognizing whether the register file of a write destination is in a writable state or not, and for example, the CPU part 30 should be stalled until the register file 462 of the vector calculation part 46 becomes writable. In the output synchronization a CPU at the preceding stage is stalled, while in the input synchronizations a CPU at the subsequent stage is stalled.

In the operation of this example, at the time when an instruction whose RFR field is set to 1 is terminated by an instruction of the vector calculation part 46, the CPU part 30 can write to the register file 462 of the vector calculation part 46. At the time when an instruction whose RFR field is set to 1 is terminated, the register file ready counter RFRC [CPU part] of the CPU part 30 is counted up. By this time, an instruction whose OSYNC is set by the CPU 30 part is stalled upon activation request. This stall condition is when the value of the register file ready counter RFRC [CPU part] is smaller than or equal to the master request counter MRC [CPU part]. When an instruction whose OSYNC is set by the CPU part 30 is activated and received, the master request counter MRC [CPU part] is counted up. Also in this method, like in the input synchronization, when the processing of a CPU at the preceding stage is extremely slow and the processing of a CPU at the subsequent stage is fast, more free space in the register file can be freed up. In this case, a stall will not occur at the time of the output synchronization of the CPU at the preceding stage. In the same way, until the register file 304 of the CPU part 30 becomes writable, in the output synchronization in which the vector calculation part 46 is stalled, the vector calculation part 46 uses OSYNC and the CPU part 30 sets the RFR field, thereby achieving the output a synchronization between two CPUs. With a combination of these input synchronization and output synchronization, a fine-grain synchronization between two CPUs at register file level is achieved. These synchronization methods are characterized in that an instruction itself includes a synchronization field.

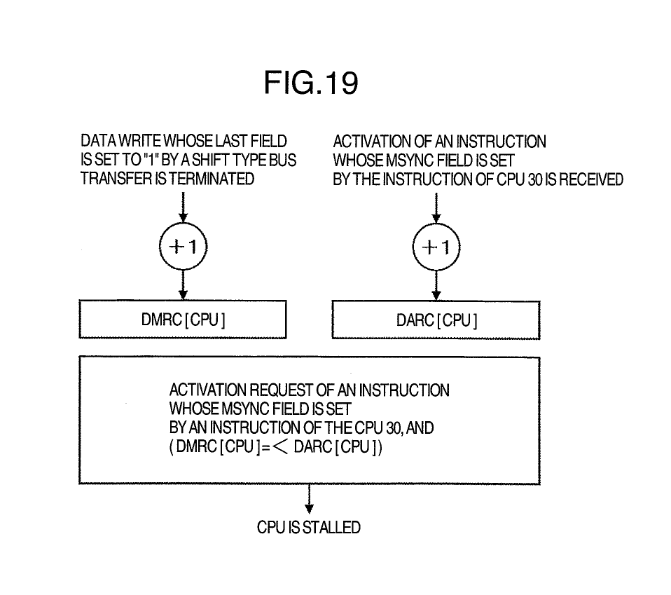

Finally, the interblock synchronization is described using FIG. 19. The interblock synchronization is a synchronization at the time when other information processing engine 6 or the like stores a data in the data memory 35 by direct memory transfer and this transfer data is used in a read instruction by the CPU part 30. The CPU part 30 needs to recognize that the direct memory transfer is completed and that all the data is stored in the data memory 35, and if not stored yet, the CPU part 30 should be stalled because the input data becomes an invalid value. That is, at the time of a read instruction, in order to check whether this read instruction is executable or not, synchronization is carried out by almost the same method as that of the input synchronization shown earlier. That is, the synchronization is carried out by comparing the magnitude relationship between two counters. The first counter is a data memory ready counter DMRC and is the counter which is counted up by a transfer with the “Last” signal when transferring by the shift type bus 50 shown earlier. This is asserted at the last transfer of direct memory transfer, i.e., at the last transfer of a two-dimensional rectangular transfer, by setting a “Last” flag of the master D register 340 of the local DMAC 34. That is, when a signal capable of recognizing that the direct memory transfer is completed is “1”, the data memory ready counter DMRC is counted up. That is, when seen from the CPU part 30, this indicates that a data is ready.

The second counter is a data memory access counter DARC and is a counter which is counted up when an instruction, whose MSYNC arranged in an operation code of a read instruction is “1”, becomes executable. Accordingly, the timing that the CPU part 30 can execute reading is when the data memory ready counter DMRC is greater than the data memory access counter DARC. In other words, if the data memory ready counter DMRC is equal to or smaller than the data memory access counter DARC, the CPU part 30 is stalled. In this way, a synchronization between blocks is enabled at instruction level of the read instruction.

In this way, according to the second embodiment, because the interval of issuing an instruction is large even when a plurality of CPUs capable of using a two-dimensional operand share an instruction memory, the performance decrease can be suppressed and the memory area can be reduced by sharing the instruction memory. Moreover, the read and write processings to the data memory 35 are carried out in the CPU part 30, the data processing is carried out in the vector calculation part 46, and the synchronization between two CPUs at register file level is carried out by a synchronization means, thereby allowing the calculation throughput to be improved. Moreover, at instruction level, the a synchronization between blocks is achieved.

### Embodiment 3

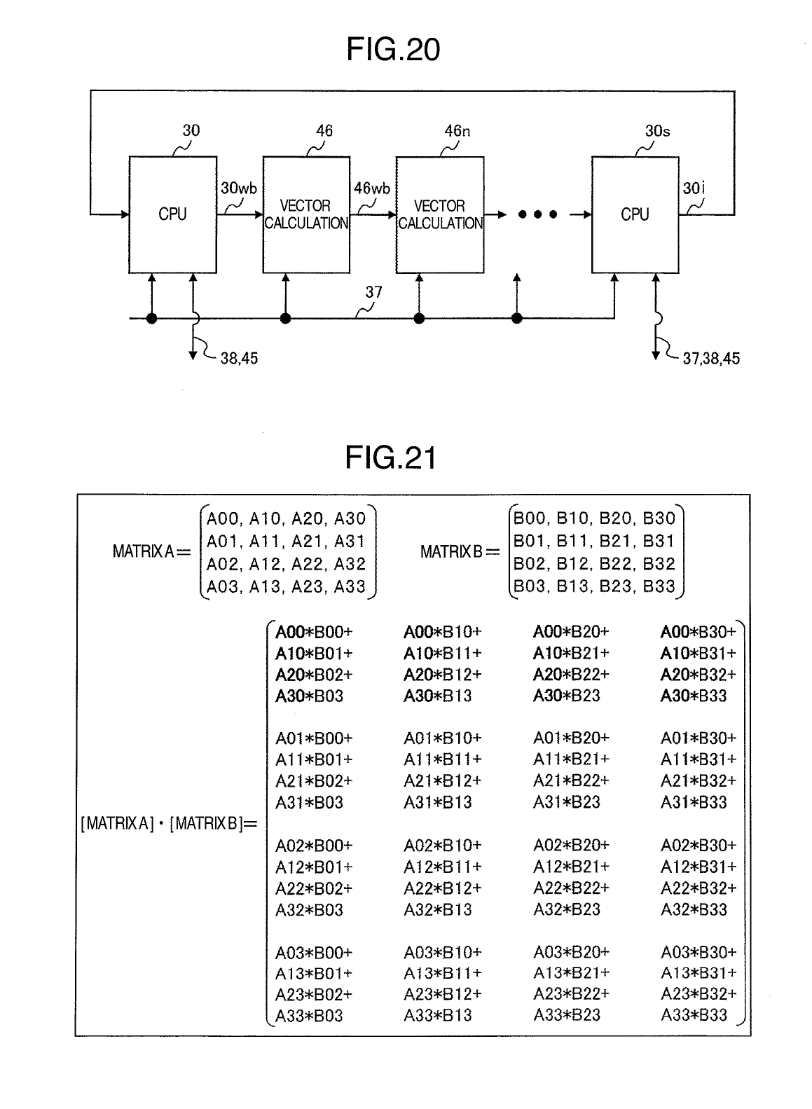

A third embodiment is described using FIG. 20. FIG. 20 shows a configuration of a CPU part arranged in the picture processing engine 66 in this embodiment. In the first embodiment, a configuration of one CPU part 30 was described, and in the second embodiment a configuration of two CPUs consisting of the CPU part 30 and vector calculation part 46 was described. In the third embodiment, two or more CPUs are connected in series and in a ring shape. In FIG. 20, the CPU part 30 capable of accessing to the data memory 35 is arranged in the front CPU, a plurality of vector calculation parts 46 and 46n are connected in series, and at the end terminal a CPU part 30s capable of accessing to the data memory 35 is connected. The calculation data 30i of the CPU part 30s is again connected to an input data part of the CPU part 30. At this time, each CPU includes a program counter, respectively, and actually includes a plurality of program counters in the instruction memory control part 47 shown in FIG. 16. The arbitration part 470 selects an instruction fetch from a plurality of instruction fetch requests 37r.

Moreover, also concerning the synchronization processing, the control thereof differs. In the description of the second embodiment, the input synchronization method and output synchronization method between the adjacent CPUs were described. Also in the third embodiment, the same synchronization processings are carried out. That is, the input synchronization and output synchronization are carried out between the adjacent CPUs. Moreover, synchronization is also carried out between the CPU part 30s at the final stage and the CPU 30 at the first stage. Moreover, the CPU part 30 and CPU part 30s both access to the data memory 35. Accordingly, the data memory control part 33 shown in FIG. 11 also controls a plurality of data memory accesses. According to this method, in the CPU part 30, a data is read from the data memory 35 and is transferred to the vector calculation part 46. The calculation result of the vector calculation part 46 is transferred to the vector calculation part 46n, and the vector calculation part 46n carries out the next processing and transfers the calculation data to the CPU part 30s. The CPU part 30s transfers the calculation result to the data memory 35, so that the data read, calculation, and data store operate in a pipeline, thereby allowing a high calculation throughput to be obtained. In particular, by forming the data memory 35 in an interleave configuration and dividing the read instruction and write instruction and dividing the blocks for direct memory access, a high throughput can be obtained.

Moreover, according to this method, even in a configuration in which two or more CPUs are connected in series and in a ring shape, a multi-CPU configuration with a synchronization between CPUs is achieved. Moreover, even when the number of CPUs increased, the number of read-write ports of a register file will not increase, thus not allowing the area of a network and register file to be increased. For example, in an increase in the number of CPUs by the VLIW configuration shown in JP-A-2001-100977, the number of ports of a register increases in proportion to the number of arithmetic logical units and the area cost increases. In contrast, in the series connection according to this method these will not increase.

Moreover, in the VLIW system, the timings that a plurality of arithmetic logical units are activated differ to each other. For example, consider an example in which in the same calculation loop, a first arithmetic logical unit carries out a memory read, and a second arithmetic logical unit carries out a general calculation, and a third arithmetic logical unit carries out a memory write. At this time, although the numbers of calculation cycles in which the respective CPUs actually operate differ, the processings are carried out in the same calculation loop and therefore the operation rate of the arithmetic logical units decreases, and as a result, the number of required processing cycles increases and the power consumption increases. On the other hand, according to this method, CPUs each are capable of including a program counter, respectively, and is capable of processing its own calculation without depending on the operation of other CPUs as well as the operation of program counters of other CPUs. For example, when changing one parameter between the fifth and sixth time loops out of 10 times of loops, although in the VLIW system the instruction sequence needs to be described with two loops of 5 times each, in this method the CPUs each have a program counter and thus only a CPU which changes the parameter can specify the instruction sequence with two loops, so that the calculation operation rate can be improved and the capacity of the instruction memory 31 to use can be reduced.

Next, there is shown an embodiment concerning a method of specifying a two-dimensional operand consisting of a Width field and a Count field in the operand of an instruction. Up till now, a reduction in the number of instructions by specifying a two-dimensional operand, and a reduction in power consumption by reducing the number of times of reading the instruction memory 31, and a reduction in power consumption and reduction in the area cost by reducing the capacity of the instruction memory 31, have been described. In addition to these, a reduction in power consumption by reducing the number of processing cycles can be also achieved. Here, the embodiment is described using inner product calculation and convolution calculation.

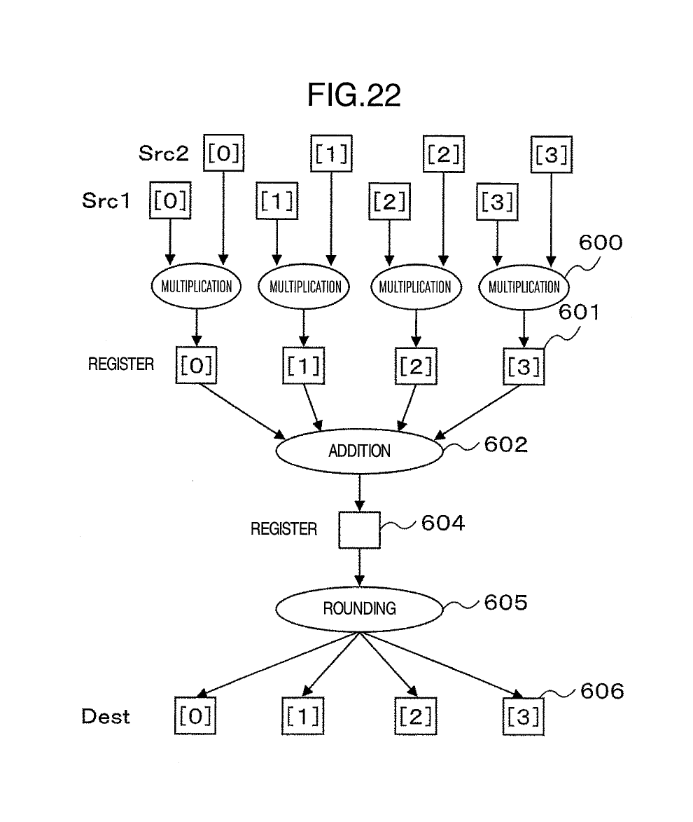

The inner product calculation is one of the generic image processings used for a video codec, an image filter, and the like. Here, an inner product calculation of 4×4 matrix is described as an example. FIG. 21 shows an example of the inner product calculation. As shown in the view, one data output of the inner product calculation of 4×4 matrix is a value obtained by executing four multiplications and then adding the results of these calculations. The same calculation is carried out to 16 elements assuming that this calculation is for a 4×4 matrix. In the description of this example, assume that the size of each data element is 16 bits (2 bytes) and that the calculation is carried out using a 64 bit width arithmetic logical unit. Moreover, assume that Matrix A and Matrix B are stored in registers in the register file 462 of the vector calculation part 46 as follows and that the calculation results are stored in Registers 8, 9, 10, and 11.
Register 0: [A00, A10, A20, A30]
Register 1: [A01, A11, A21, A31]
Register 2: [A02, A12, A22, A32]
Register 3: [A03, A13, A23, A33]
Register 4: [B00, B10, B20, B30]
Register 5: [B01, B11, B21, B31]
Register 6: [B02, B12, B22, B32]
Register 7: [B03, B13, B23, B33]
   In this way, two-dimensional inner product calculation is characterized in that a plurality of registers are used for the calculation input. In a general 4-parallel SIMD type arithmetic logical units for issuing one instruction per one cycle, as shown in FIG. 22, the processing is carried out with the following instruction sequence. In addition, assume that the transposed values are stored in Matrix A as follows.
Register 0: [A00, A01, A02, A03]
Register 1: [A10, A11, A12, A13]
Register 2: [A20, A21, A22, A23]
Register 3: [A30, A31, A32, A33]
Instruction 1: Product sum operation with Src1 (Register 0), Src2 (Register 4), and Dest (Register 8 [0]).
Instruction 2: Product sum operation with Src1 (Register 0), Src2 (Register 5), and Dest (Register 8 [1]).
Instruction 3: Product sum operation with Src1 (Register 0), Src2 (Register 6), and Dest (Register 8 [2]).
Instruction 4: Product sum operation with Src1 (Register 0), Src2 (Register 7), and Dest (Register 8 [3]).

With these four instructions, the first row of the inner product calculation is calculated and then by changing Src1 register, four rows of calculations are carried out. Accordingly, a total of 16 instructions are calculated consuming 16 cycles. In addition, as a pre-processing, the transposition of Matrix A is required. Accordingly, the number of required cycles is actually greater than 16 cycles.

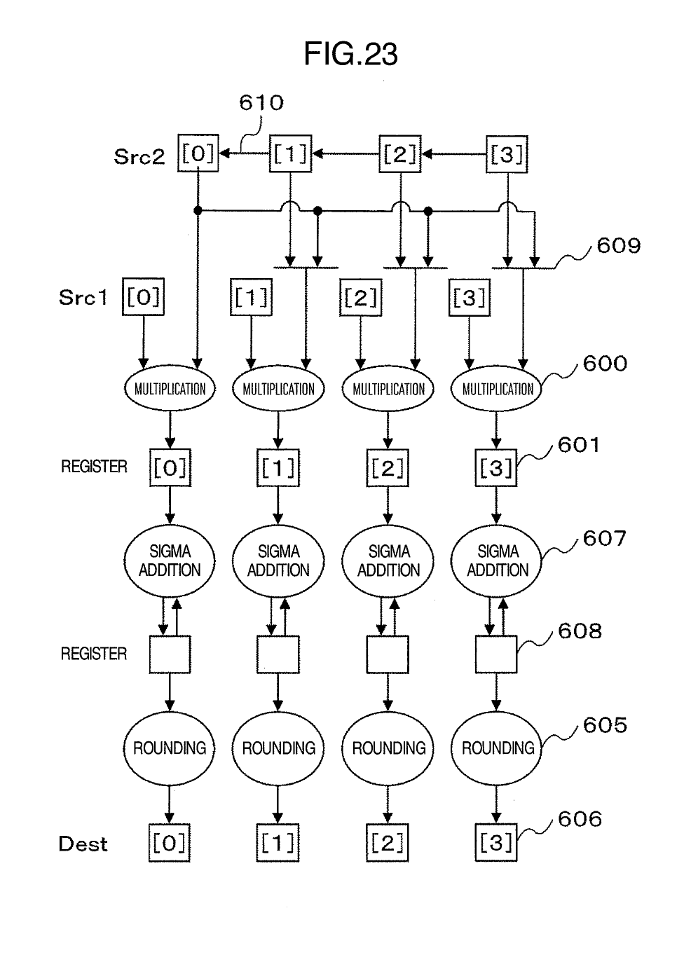

On the other hand, in this embodiment capable of specifying a two-dimensional operand, a configuration of an arithmetic logical unit shown in FIG. 23 is employed. As compared with the SIMD type arithmetic logical unit shown in FIG. 22, a selector 609 is arranged at the preceding stage of the Src2 input to select and input values of Src2 and of Src2 [0]. Moreover, for each one cycle calculation, a path 610 is used to shift left the value of Src2. Moreover, an output of a register 601 which stores the calculation result of a multiplier 600 is inputted to a sigma adder 607, and the calculation result of the sigma adder 607 is stored in a register 608. The sigma adder 607 is an arithmetic logical unit which carries out the sigma addition of the result of the register 601 and the result of the register 608, sequentially. In this example, 4 cycles of multiplication results are sigma-added and rounded to thereby obtain a calculation result as Dest.

Pay attention to the first row of the calculation result of the example of inner product calculation of FIG. 21. While for Matrix B, 16 elements of data input are required, the inputs for Matrix A are A00, A10, A20, and A30, which are only values stored in the register 0. Moreover, for the multiplication of the first element, A00 is always inputted. The processing example of this calculation is achieved with the arithmetic logical unit shown in FIG. 23. In Src1, Matrix B. i.e., Register 4, is set, while in Src2, Matrix A, i.e., Register 0, is set. At the Src1 side, whenever a clock is supplied, it is supplied to Register 4, Register 5, Register 6, and Register 7, and again Register 4 in this order. At the Src2 side, Register 0 is inputted in the first cycle, and Registers are left shifted using the bus 610 in the second, third, and fourth cycles. At this time the selector 609 selects Src2 [0] data. Accordingly, the Src2 output will be A00 in the first cycle, A10 in the second cycle, A20 in the third cycle, and A30 in the fourth cycle. In the fifth cycle, Register 1 is supplied, and in the sixth, seventh and eighth cycles, Registers are shifted in the same way. With such data supply, one row of calculation results can be obtained in 4 cycles. Accordingly, a calculation result Dest 606 is generated once every 4 cycles, and with this timing the register file 462 is updated. With this method, the area of a register file can be reduced without requiring a byte enable when writing to the register file 462, and the inner product calculation is realized in a total of 16 cycles without requiring the transposition of data.

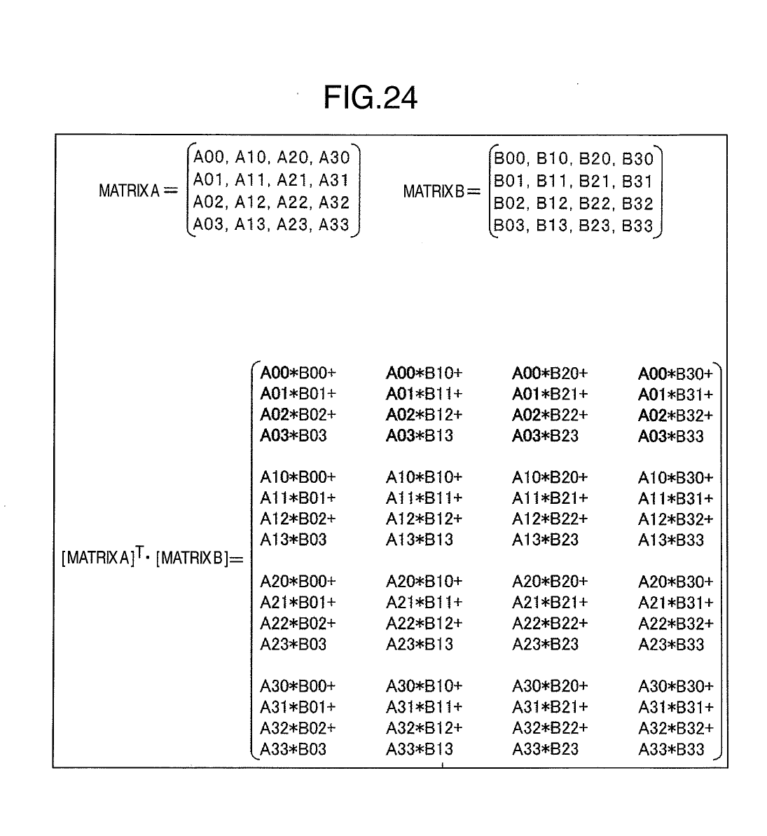

Next, for the inner product calculation with respect to the transposed matrix, the operation thereof is described using an example of inner product calculation of FIG. 24. FIG. 24 shows the inner product when Matrix A which is the first matrix is transposed. Also here, pay attention to the first row of the calculation result. While for Matrix B, 16 elements of data input are required, the inputs for Matrix A are A00, A01, A02, and A03, which are only values stored in a data element [0] of Register 0 to Register 3. In this calculation, as compared with the above-described inner product calculation without transposition, the first matrix realizes the inner product calculation of the transposition by changing a method of supplying Src2. While in the above-described matrix calculation without transposition, the data is supplied by shifting Src2 using the path 610 in Cycles 2, 3, and 4, in this example Register 0 is used in Cycle 1, Register 1 is used in Cycle 2, Register 2 is used in Cycle 3, and Register 3 is used in Cycle 4. The data element [0] of Register 0 to Register 3 is used in the inner product of the first row, the data element [1] is used in the inner product of the second row, the data element [2] is used in the inner product of the third row, and the data element [3] is used in the inner product of the fourth row. With this method, the inner product calculation of the transposed first matrix is realized by changing only the method for supplying Src2 shown earlier. At this time, there is no different operation in the data path after the multiplier. Accordingly, although a general SIMD type arithmetic logical unit needs a transposition as a pre-processing before the inner product calculation, this method does not require this and thus the number of processing cycles can be reduced.

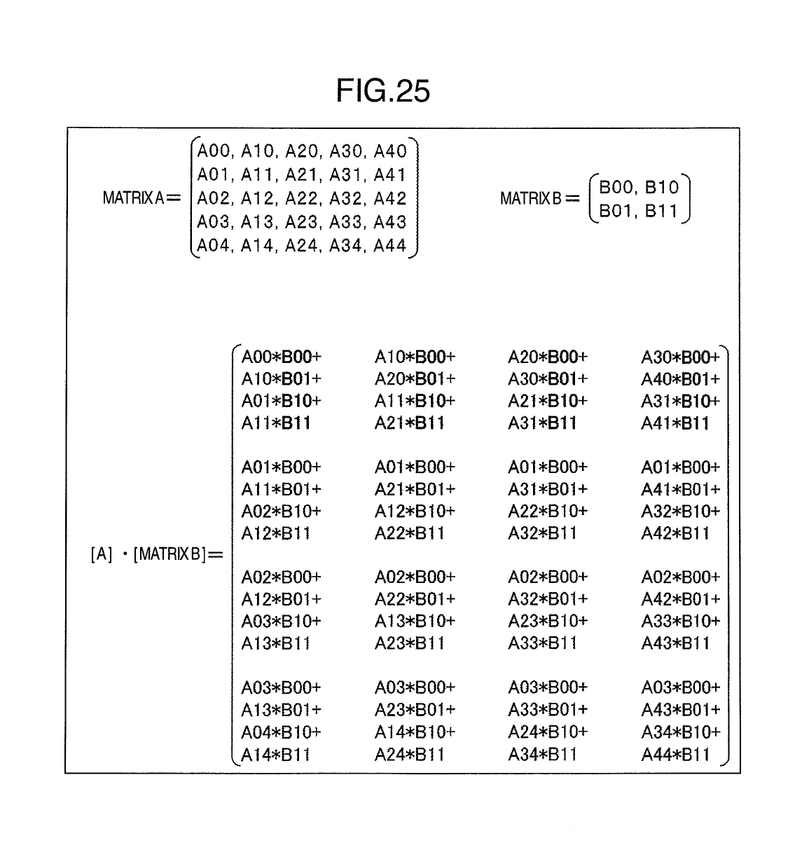

In addition, in a matrix calculation in which only the second matrix is transposed, the same data supply as that of the inner product without transposition is carried out for the inputs of Src1 and Src2, and the arithmetic logical unit is realized with a configuration in which four elements are added in one cycle like in the ordinary SIMD type arithmetic logical unit. In this method, the outputs of four Registers 601 are added without using Register 608 at the input of the sigma adder 607. Next, an operation example of a convolution calculation is described. The convolution calculation is used in filtering processing, edge enhancement, and the like, by a low pass filter, high pass filter, and the like of images. Moreover, this calculation is also used in a motion compensation processing in a video codec. In the convolution calculation, unlike the inner product calculation, the second matrix (serve as a convolution coefficient) is fixed, and with this convolution coefficient the calculation is carried out to the whole data elements of the first matrix. FIG. 25 shows an example of a two-dimensional convolution calculation. As shown in the view, to the whole data elements of the output data, the convolution coefficient of the second array is multiplied and sigma added.

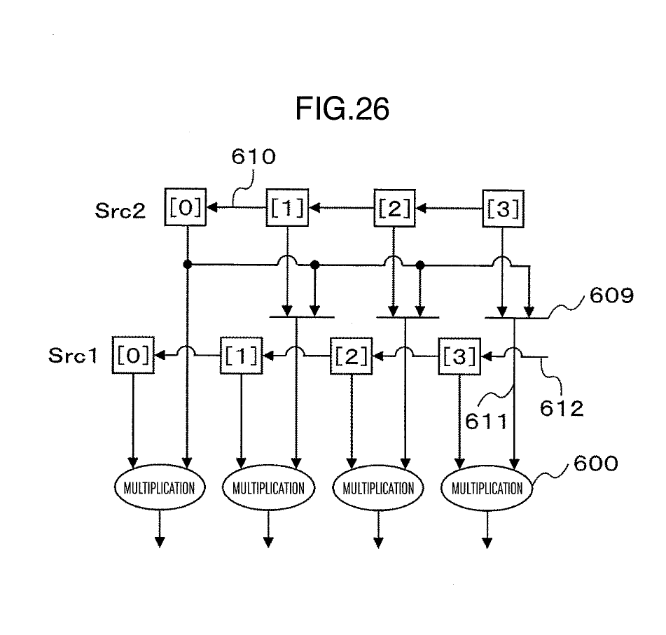

FIG. 26 shows a part of a configuration of an arithmetic logical unit for achieving this. This configuration shows a configuration before the input to Register 601 in the configuration of the inner product calculation unit shown in FIG. 23. The difference from the configuration of the inner product calculation unit is that Src1 is formed similarly in a shift register configuration by a path 612. The operation of the convolution calculation is shown. First, assume that Array A and Array B are arranged in registers in advance as shown below. At this time, the data of the first to fourth rows of Array A and the data of the fifth row are arranged in different registers. Array B is arranged in one register.
Register 0: [A00, A10, A20, A30]
Register 1: [A40, blank, blank, blank]
Register 2: [A01, A11, A21, A31]
Register 3: [A41, blank, blank, blank]
Register 4: [A02, A12, A22, A32]
Register 5: [A42, blank, blank, blank]
Register 6: [A03, A13, A23, A33]
Register 7: [A43, blank, blank, blank]
Register 8: [B00, B01, B10, B11]
   Register 0 is inputted to Src1 and Register 8 is inputted to Src2. At this time, for the output of Src2, the first data element of Src2 is inputted by the selector 609. Namely, Src2 [0], Src2 [0], Src2 [0], and Src2 [0] are inputted. The outputs of four multipliers 600 in the first cycle are as follows. The first cycle:
600 [0] Output: A00*B [00]
600 [1] Output: A10*B [00]
600 [2] Output: A20*B [00]
600 [3] Output: A30*B [00]

### In the second cycle, both Src1 and Src2 are left shifted using the paths 610 and 612. In Src1, A40, which is the first data element of Register 1, is inputted to [3] of Src1. As a result, the outputs of four multipliers 600 are as follows.

The second cycle:
600 [0] Outputs: A10*B [01]
600 [1] Outputs: A20*B [01]
600 [2] Outputs: A30*B [01]
600 [3] Outputs: A40*B [01]

### In the third cycle, Src2 is left shifted using the path 612. Src1 updates a read register pointer and inputs Register 2. As a result, the outputs of four multipliers 600 are as follows.

The third cycle:
600 [0] Output: A01*B [10]
600 [1] Output: A11*B [10]
600 [2] Output: A21*B [10]
600 [3] Output: A31*B [10]

### In the fourth cycle, like in the second cycle, both Src1 and Src2 are left shifted using the path 612. As a result, the outputs of four multipliers 600 are as follows.

The fourth cycle:
600 [0] Output: A11*B [10]
600 [1] Output: A21*B [10]
600 [2] Output: A31*B [10]
600 [3] Output: A41*B [10]

By sigma adding these 4 cycles of data in the sigma adder 607, a convolution calculation result of the first row is obtained. In the fifth cycle, again by inputting Register 2 to Src1 and inputting Register 8 to Src2, the convolution calculation of the second row is carried out. As a result, the convolution calculation results of 4×4 matrix is obtained in 16 cycles.

In addition, in these descriptions, although a shift register is used for supplying Src1 and Src2, the same effect is obtained by selecting the data using a selector and carrying out the same data supply. Accordingly, the invention is characterized by a means for supplying data.

In the general SIMD type arithmetic logical unit shown in FIG. 22, the vertical convolution calculation uses a product sum operation for each data element. However, because data rounding is required when four product sum operations are completed, the product sum operation should be executed by extending 8 bit data to 16 bit data at a stage of each product sum operation. Moreover, when four product sum operations are completed, again 16 bit data is rounded into 8 bit data. At the time of the product sum operation, due to the bit extension the number of arithmetic logical units actually used in parallel is halved and the number of processing cycles increases. Moreover, the number of calculation cycles of the bit extension itself and the rounding itself increases. The number of processing cycles can be reduced by specifying a two-dimensional operand as in this method.

On the other hand, in the horizontal convolution calculation by the general SIMD type arithmetic logical unit shown in FIG. 22, whenever a data element is generated, Array A should be shifted in the unit of data element to be inputted to the arithmetic logical unit, thus increasing the number of processing cycles. Moreover, in the two dimensional convolution, the number of processing cycles increases due to the bit extension, shift, rounding, and the like.

Accordingly, specifying a two-dimensional operand as in this method means expressing a plurality of source instructions with one instruction, so that it is possible to reduce the processing cycles, including a pre-processing and a post-processing other than truly required product sum operation. As a result, the processing can be realized with a low operation frequency and the power consumption can be reduced further.

It should be further understood by those skilled in the art that although the foregoing description has been made on embodiments of the invention, the invention is not limited thereto and various changes and modifications may be made without departing from the spirit of the invention and the scope of the appended claims.

1. A picture processing engine, comprising an instruction memory; a data memory; and CPU, wherein
the CPU further includes: an instruction decoder; a general-purpose register; and an arithmetic logical unit, and wherein
an instruction operand of the CPU includes: a field for specifying the number of data counts, the data counts indicating a data width and a height direction; a source register pointer indicating a starting point of the general-purpose register in which a data used for calculation processing is stored; and a destination register pointer indicating a starting point of a general-purpose register in which a calculation result is stored,
the picture processing engine further including a means which sequentially generates an address of the source register and an address of the destination register to access for each cycle, based on the data width, the number of data counts, the source register pointer, and the destination register pointer, wherein
a data read from the source register is inputted to the arithmetic logical unit to execute calculation, and an obtained calculation result is stored sequentially in the destination register, thereby executing a plurality of calculations by consuming a plurality of cycles with one instruction.

2. The picture processing engine according to claim 1, wherein
in the CPU,
an operand of an instruction, the instruction issuing a read instruction and a write instruction to the data memory, includes a field for specifying a data width, the number of data counts, and a data interval, and wherein
at the time of access to the data memory, a data memory address capable of expressing a two-dimensional rectangular is generated from the data width, the number of data counts, and the data interval, and with the use of this data memory address the data memory is accessed over a plurality of times by consuming a plurality of cycles with one instruction, thereby allowing a two-dimensional data to be accessed with one instruction.

3. The picture processing engine according to claim 1, wherein
the CPU includes a convolution calculation instruction and an inner product calculation instruction which the CPU issues, wherein
a data input stage for inputting a source data, the source data being specified and read by the source register pointer, includes: a means which shifts and outputs the source data for each clock to be supplied; and a means which generates a source register address and a destination register address dedicated for the convolution calculation and the inner product calculation, wherein
the arithmetic logical unit has a multiplier, a sigma adder, and a data rounding processing part connected in series, and is capable of executing one-dimensional or two-dimensional convolution calculation described-above and the inner product calculation with one instruction.

4. The picture processing engine according to claim 1, wherein
the CPU includes: a plurality sets of instruction registers for storing an instruction read from the instruction memory; and
the CPU further including a means which reads a next instruction automatically when either one of the instruction registers is not valid, wherein
at the time of the instruction read, if a read instruction is a branch instruction, the branch instruction is not stored in the instruction register, but an instruction of a branch destination is read immediately, and the instruction of the branch destination is stored in the instruction register, and wherein
one of operands of the branch instruction includes a field which specifies a branch condition register for specifying whether to branch or not,
the CPU further including a means which determines whether to branch or not, depending on a value of a selected branch condition register at the time of the branch instruction, wherein
if not to branch, a next instruction is read and the branch instruction is not stored in the instruction register, and an instruction read from the instruction memory is not carried out every cycle, thereby masking a cycle which it takes to re-read the instruction by the branch instruction.

5. The picture processing engine according to claim 1, further including: a plurality of CPUs according to any one of claims 1 to 3; and a means which stores each calculation result of the plurality of CPUs into a register of an adjacent CPU, wherein the plurality of CPUs are connected to adjacent CPUs, and a CPU at a final stage is connected to a CPU at a first stage, thereby providing a ring shaped connection.

6. The picture processing engine according to claim 5, wherein
an operand of an instruction which the CPU issues includes a first flag for determining whether or not a data can be stored in a register, which register a CPU at the next stage side of the CPU has, and wherein
an operand of an instruction which the CPU at the next stage side issues includes a second flag indicating whether a data writing from the CPU at the preceding stage is receivable or not,
the picture processing engine further including a circuit which carries out a synchronization between adjacent two CPUs by means of the first and second flags, wherein a CPU at the preceding stage includes a means to stall if the writing is not possible, wherein an operand of an instruction which the CPU issues includes a third flag for determining whether a data is available or not after completing a data write from the CPU at the preceding stage to a register, and the operand of an instruction which the CPU at the preceding stage issues includes a fourth flag for notifying that a data write to the CPU at the subsequent stage is completed, the picture processing engine further including: a circuit which carries out a synchronization between two CPUs from the information on the third and fourth flags; and a means which outputs a stall signal for causing the CPU at the subsequent stage to wait when a data preparation is not completed yet, wherein
an operand of an instruction includes a flag for carrying out a synchronization between adjacent two CPUs, the picture processing engine further including a circuit which controls the synchronization together with these flags.

7. The picture processing engine according to claim 5, wherein the plurality of CPUs share an instruction memory and returns an instruction for each cycle by time division.

8. A picture processing system, comprising a picture processing part in which a plurality of the picture processing engines include an instruction memory; a data memory; and CPU, wherein
the CPU further includes: an instruction decoder; a general-purpose register; and an arithmetic logical unit, and wherein
an instruction operand of the CPU includes: a field for specifying the number of data counts, the data counts indicating a data width and a height direction; a source register pointer indicating a starting point of the general-purpose register in which a data used for calculation processing is stored; and a destination register pointer indicating a starting point of a general-purpose register in which a calculation result is stored,
the picture processing engine further including a means which sequentially generates an address of the source register and an address of the destination register to access for each cycle, based on the data width, the number of data counts, the source register pointer, and the destination register pointer, wherein
a data read from the source register is inputted to the arithmetic logical unit to execute calculation, and an obtained calculation result is stored sequentially in the destination register, thereby executing a plurality of calculations by consuming a plurality of cycles with one instruction,
said plurality of picture processing engines being connected in series via a bus, wherein
each of the picture processing engines includes a direct memory access controller, the direct memory access controller reading a data from a data memory which one of the picture processing engines has, and transferring the data to a data memory in one of the other picture processing engines, wherein
the CPU includes a means for activating and controlling the direct memory access controller and is capable of carrying out a data transfer between a plurality of picture processing engines by direct memory access.

9. The picture processing system according to claim 8, wherein
the picture processing part includes, as one of blocks connected to a bus, in addition to the picture processing engine, a data transfer circuit comprising: an internal bus master control part and an internal bus slave control part which carry out data transfer between a second internal bus, such as a system bus, and the bus; and an internal bus bridge, wherein
the data transfer circuit is capable of accessing to an external memory via the second bus, thereby allowing for data transfer between each of the picture processing engines and the external memory.

10. The picture processing system according to claim 9, further comprising a first bus comprised of a plurality of shift registers, in which first bus a plurality of data transfers are possible simultaneously between the shift registers, respectively, and the connection directions of the shift registers are opposite to each other, wherein
one of the first buses carries out data transfer between picture processing engines and in the direction from the picture processing engine to the data transfer circuit, and wherein
other one of the first buses carries out data transfer of a data to each picture processing engine via the internal bus and the data transfer circuit, the data being read from an external memory, so that the plurality of first buses prevents a conflict of the data transfer between the picture processing engines and the data transfer from an external memory from occurring, or allows the frequency of the conflict to be reduced.
